(19) United States
(12) Patent Application Publication
(10) Pub. No.: US 2026/0059594 A1
(43) Pub. Date: Feb. 26, 2026

(54) SYSTEMS AND METHODS FOR SIXTH GENERATION DUAL CONNECTIVITY

(71) Applicant: APPLE INC., Cupertino, CA (US)

(72) Inventors: Fangli Xu, Beijing (CN); Xiaoyu Qiao, Beijing (CN); Yuqin Chen, Beijing (CN); Haijing Hu, Los Gatos, CA (US); Naveen Kumar R. Palle Venkata, San Diego, CA (US); Ralf Rossbach, Munich (DE); Shu Guo, Beijing (CN); Peng Cheng, Beijing (CN); Zhibin Wu, Los Altos, CA (US); Behrouz Aghili, San Diego, CA (US); Huarui Liang, Beijing (CN)

(21) Appl. No.: 19/305,050

(22) Filed: Aug. 20, 2025

Related U.S. Application Data
(60) Provisional application No. 63/684,933, filed on Aug. 20, 2024.

(51) Int. Cl. H04W 76/15; H04W 12/041; H04W 24/08

(52) U.S. Cl. CPC H04W 76/15; H04W 12/041; H04W 24/08

(57) ABSTRACT

Systems and methods for sixth generation (6G) dual connectivity (DC) are discussed. A user equipment (UE) establishes a connection with a first node through a first cell group (CG) of the first node; sends, to the first node, a DC request comprising an indication of a preferred target cell; receives, from the first node, in response to the DC request, a configuration message comprising an identification of a second CG of a second node to use with the first CG of the first node in a DC mode; and initiates, in response to the configuration message, the DC mode with the first CG of the first node and the second CG of the second node. Corresponding network functionalities are also discussed.

### CROSS-REFERENCE TO RELATED APPLICATION

This application claims the benefit of U.S. Provisional Patent Application No. 63/684,933, filed Aug. 20, 2024, entitled “METHODS AND APPARATUS FOR SIXTH GENERATION DUAL CONNECTIVITY,” which is hereby incorporated by reference herein in its entirety.

### TECHNICAL FIELD

This application relates generally to wireless communication systems, including wireless communication systems implementing dual connectivity (DC).

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates aspects of first cases discussed herein where a UE is configured with two CGs, and either/both of these CGs can be activated and/or deactivated independently of the other CG.

FIG. 2 illustrates aspects of second cases discussed herein where a UE is configured with two CGs but at most one of these two CGs can be activated at any given time.

FIG. 3 illustrates aspects of third cases discussed herein where a UE is only configured with/applied with one CG at a time.

FIG. 4 illustrates a flow diagram for a DC configuration procedure according to embodiments discussed herein.

FIG. 5 illustrates a flow diagram for a DC configuration procedure that shifts anchor node status from a 5G node to a 6G node, according to embodiments discussed herein.

FIG. 6 illustrates a diagram for a changing security key configuration at a UE 602 corresponding to a CG change.

FIG. 7 illustrates a first pathing and a second pathing for an SRB #1 that is configured to operate with/through a 6G node according to a split configuration within a 6G MR-DC architecture.

FIG. 8 illustrates a first pathing for an SRB #1 that is configured to operate with/through a 6G node within a 6G MR-DC architecture and a second pathing for an SRB #3 that is configured to operate with/through a 5G node within the 6G MR-DC architecture.

FIG. 9 illustrates a flow diagram for CG activation and CG deactivation at a UE, according to embodiments discussed herein.

FIG. 10 illustrates a flow diagram for CG activation and CG deactivation at a UE, according to embodiments discussed herein.

FIG. 11 illustrates a flow diagram for CG activation and CG deactivation at a UE, according to embodiments discussed herein.

FIG. 12 illustrates a protocol stack model used to discuss a case where a UE is configured with only one CG at a time.

FIG. 13 illustrates an a flow diagram implementing a first option for RRC configuration when a UE is configured with only one CG at a time.

FIG. 14 illustrates an a flow diagram implementing a second option for RRC configuration when a UE is configured with only one CG at a time.

FIG. 15 illustrates an a flow diagram implementing a third option for RRC configuration when a UE is configured with only one CG at a time.

FIG. 16 illustrates a method of a UE, according to embodiments discussed herein.

FIG. 17 illustrates a method of a first node, according to embodiments discussed herein.

FIG. 18 illustrates a method of a first node, according to embodiments discussed herein.

FIG. 19 illustrates an example architecture of a wireless communication system, according to embodiments disclosed herein.

FIG. 20 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Embodiments herein relate to the dual connectivity (DC) of a UE to each of a first RAN node and a second RAN node. Note that discussion herein may use the terms “RAN node” and “node” equivalently.

Candidate solutions for 5G to 6G migration when considering 6G deployment scenarios may include multi-RAT spectrum sharing (MRSS), multi-RAT dual connectivity (MR-DC), and dual stack operation. Embodiments herein describe aspects of MR-DC for 6G and forward. These may be referred to herein at times as “6G MR-DC” cases or embodiments. As used herein, the term “6G” should be understood to include consideration of RAT(s) developed in view of/as improvements to presently deployed RATs, including, e.g., 5G RAT, LTE RAT, etc.

Over time, various issues and complexities of the MR-DC design used in 5G have become apparent. For example, 5G MR-DC design has a relatively high deployment complexity, where many options, including E-UTRA-NR dual connectivity (EN-DC), NG-RAN E-UTRA-NR dual connectivity (NGEN-DC), NG-RAN E-UTRA-NR dual connectivity (NGEN-DC), and NR-NR dual connectivity (NR-DC), are supported. However, only EN-DC presently enjoys wide adoption in in-field deployments. Further, 5G MR-DC design assumes a relatively high UE complexity, in that the UE is required to support simultaneous receive (Rx)/transmit (Tx) through both a main cell group (MCG) and a secondary cell group (SCG). Still further, 5G MR-DC design assumes a high RAN complexity, in that RAN coordination between a main node (MN) and a secondary node (SN) is required for MR-DC UE configuration and scheduling. Finally, 5G MR-DC design uses a relatively complex UE capability design, in that aspects of a MR-DC UE capability are reported across separate capability containers.

Accordingly, various embodiments for 6G MR-DC design provided herein relate to a relative reduction of complexity for one or more of these aspects of the 5G MR-DC complexity. Various embodiments herein relate to cases where aspects of coordination that are used between nodes in 5G MR-DC (e.g., as between an MN and SN in the 5G MR-DC case) are relatively loosened. Further, various embodiments herein relate to cases for relaxing and/or avoiding a requirement for simultaneous Rx/Tx operation at a UE side.

Corresponding to various embodiments discussed herein, UE complexity is reduced relative to 5G MR-DC via a relaxation of a requirement for a capability or support of simultaneous Rx/Tx UE capability via an MCG and an SCG (as is the case in 5G MR-DC).

Corresponding to various embodiments discussed herein, RAN complexity is reduced relative to 5G MR-DC via a relaxation of the level of coordination used between nodes (e.g., as in the case of coordination between an MN and SN in 5G MR-DC) for configuration and/or scheduling of an MR-DC UE.

Corresponding to various embodiments discussed herein, a 6G MR-DC UE capability design is simplified relative to 5G MR-DC. Because it is conceivable in such embodiments to have a case where simultaneous Rx/Tx is not used at the UE side, capability reporting which is needed for concurrent Rx/Tx operation can be avoided (e.g., such as capability reporting for dynamic power sharing, etc.).

Corresponding to various embodiments herein, it may be assumed that a switch between 5G-RAT operation and 6G-RAT operation at a UE is anchored at the RAN side. In such cases, it may be that an anchor RAN node for the UE is not changed. Accordingly, a CN connection of the UE is not impacted.

In first cases for 6G MR-DC discussed herein, a UE is configured with two CGs (e.g., 5G CG and a 6G CG) across two RAN nodes, and either of these CGs can be activated and/or deactivated independently of the other CG. In such circumstances, it may be that the UE treats these to CGs as having the same priority. Benefits corresponding to such first cases include that the UE is not required to keep any particular one of these CGs activated, which is good for UE power. Compare this to the case of 5G MR-DC, where the UE is required to keep a designated MCG of an MN activated at all times (unless and until a full handover to a new MCG/MN occurs).

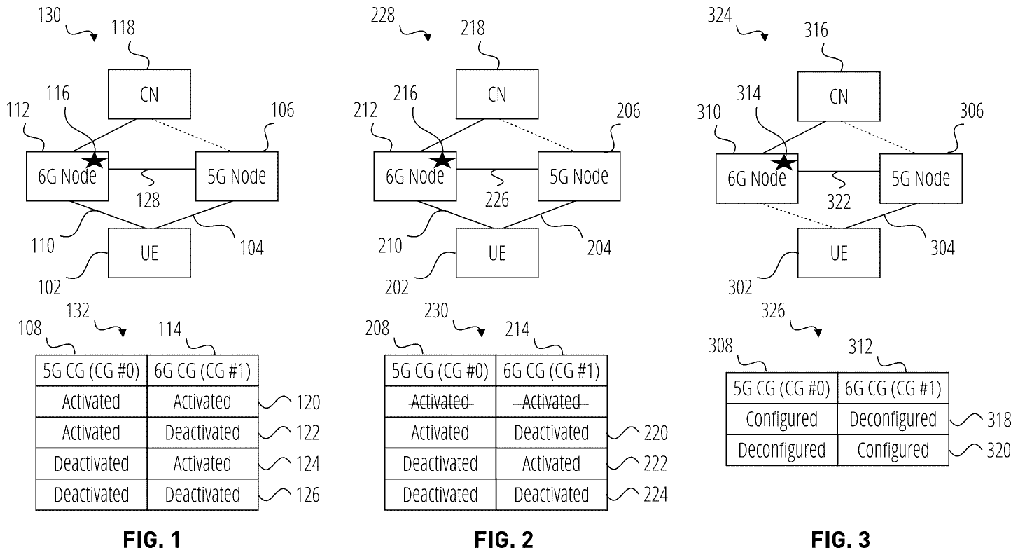

FIG. 1 illustrates aspects of first cases discussed herein where a UE is configured with two CGs, and either/both of these CGs can be activated and/or deactivated independently of the other CG. A diagram 130 illustrates that a UE 102 is configured with each of a first connection 104 to a 5G node 106 via a 5G CG 108 (a “CG #0”) made up of one or more cells of the 5G node 106 and a second connection 110 to a 6G node 112 via a 6G CG 114 (a “CG #1”) made up of one or more cells of the 6G node 112. The 5G node 106 and the 6G node 112 may communicate with each other via the inter-node interface 128. As illustrated, the 6G node 112 acts as the anchor node 116 to a CN 118 for the UE 102.

A table 132 illustrates available activation options for the 5G CG 108 and the 6G CG 114 corresponding to such first cases. In a first activation option 120, each of the 5G CG 108 and the 6G CG 114 is activated. In a second activation option 122, the 5G CG 108 is activated with the 6G CG 114 is deactivated. In a third activation option 124, the 5G CG 108 is deactivated while the 6G CG 114 is activated. In a fourth activation option 126, each of the 5G CG 108 and the 6G CG 114 is deactivated.

In second cases for 6G MR-DC discussed herein, a UE is configured with two CGs but at most one of these two CGs can be activated at any given time. (Note that viewed one way, these second cases may be understood as a subset of the first cases previously described.) In these second cases, only one CG is used for data transmission. However, the UE maintains both CG connections for at least some minimum set of functions (e.g., for radio link monitoring (RLM) purposes, measurement purposes, etc.). Benefits of such second cases include that the UE is not required to support simultaneous Rx/Tx across both CGs. This is good for UE power consumption. Further, corresponding to such cases, cross-CG coordination/complexity at both the UE and/or the network side can be avoided or reduced relative to cases for 5G MR-DC.

FIG. 2 illustrates aspects of second cases discussed herein where a UE is configured with two CGs but at most one of these two CGs can be activated at any given time. A diagram 228 illustrates that a UE 202 is configured with each of a first connection 204 to a 5G node 206 via a 5G CG 208 (a “CG #0”) made up of one or more cells of the 5G node 206 and a second connection 210 to a 6G node 212 via a 6G CG 214 (a “CG #1”) made up of one or more cells of the 6G node 212. The 5G node 206 and the 6G node 212 may communicate with each other via the inter-node interface 226. As illustrated, the 6G node 212 acts as the anchor node 216 to a CN 218 for the UE 202.

A table 230 illustrates available activation options for the 5G CG 208 and the 6G CG 214 corresponding to such second cases. In a first activation option 220, the 5G CG 208 is activated while the 6G CG 214 is deactivated. In a second activation option 222, the 5G CG 208 is deactivated while the 6G CG 214 is activated. In a third activation option 224, each of the 5G CG 208 and the 6G CG 214 is deactivated. Note that there is no activation option where each of the 5G CG 208 and the 6G CG 214 is activated simultaneously.

In third cases for 6G MR-DC discussed herein, a UE is only configured with/applied with one CG at a time. In such third cases, a switch between CGs (e.g., between a 6G CG and 5G CG) represents is a change in a CG configuration of a radio resource control (RRC) configuration mechanism, but there is no CN change. Further, it follows that only the configured CG is used for data transmission, and that a connection is maintained only for the configured CG (meaning that, e.g., RLM and/or measurement occurs only on the configured CG). Benefits of such third cases include that the UE is not required to support simultaneous Rx/Tx and that the UE not more generally required to maintain connections to two CGs. UE power and coordination complexity are each correspondingly reduced relative to 5G MR-DC cases.

FIG. 3 illustrates aspects of third cases discussed herein where a UE is only configured with/applied with one CG at a time. A diagram 324 illustrates that a UE 302 is configured (only) a first connection 304 to a 5G node 306 via a 5G CG 308 (a “CCG #0”) made up of one or more cells of the 5G node 306 (and is not configured with any connection to a 6G node 310 via a 6G CG 312 (a “CG #1”) made up of one or more cells of the 6G node 310. The 5G node 306 and the 6G node 310 may communicate with each other via the inter-node interface 322. As illustrated, the 6G node 310 acts as the anchor node 314 to a CN 316 for the UE 302 (through the inter-node interface 322).

A table 326 illustrates available configuration options for the 5G CG 308 and the 6G CG 312 corresponding to such third cases. In a first configuration option 318, the UE 302 not configured with the 6G CG 312 while it is configured with the 5G CG 308. In a second configuration option 320, the UE 302 is not configured with the 5G CG 308 while it is configured with the 6G CG 312. Note that the presented state of the diagram 324 corresponds to the first configuration option 318 found in the table 326.

Embodiments for UEs Configured with Two CGs Across Two RAN Nodes, where Either CG can be Activated and/or Deactivated Independently of the Other CG

Embodiments for UEs configured with two CGs across two RAN nodes, where either CG can be activated and/or deactivated independently of the other CG, are now discussed.

Note that under 5G MR-DC, a particular MCG is always activated in order to maintain the RRC connection of the UE with the network. Then, in cases of MCG failure, UE will initiate, for example, an RRC connection reestablishment procedure or a fast MCG failure recovery procedure. Further, in 5G MR-DC scenarios, mobility related-measurements are based on a measurement configuration for an MCG by an MN.

Alternatively, in various 6G MR-DC cases related herein, there is no differentiation between the two CGs with respect to Uu interface aspects. Each of the two CGs have the same role at the UE side. Further, either CG can be activated and/or deactivated by network signaling and/or by the UE itself.

With respect to network operation aspects, from a CN side, a connection to the UE is maintained by the anchor RAN node. The two RAN nodes may communicate with each other using an inter-node interface. For the Uu interface, the network configures the UE with two CGs across the RAN nodes (e.g., a CG #0 of a first RAN node and CG #1 of a second RAN node) and each CG can be configured with/operate according to an associated RAT. For example, it may be that the first RAN node operates according to 5G RAT while the second RAN node operates according to a 6G RAT.

With respect to the configuration for each of these CGs, the network may provide for an initial state (i.e. activated/deactivated).

Mobility of the UE as between nodes of the RAN can be based on a measurement configured for/by either the first RAN node and/or the second RAN node.

Further, UE operation is the same for/on both CGs. An RRC connection for the UE can be maintained via either CG link. RRC signaling can be delivered via either CG (or even both CGs) based on a corresponding network configuration.

Further in 6G MR-DC cases discussed herein, in addition to signaling radio bearer (SRB) splitting/duplication, the network can also configure different SRBs for a same message transmission but over different CGs. With respect to SRB use generally, the network can flexibly configure whether the RB is anchored in a first CG of the first RAN node or in a second CG of the second RAN node.

When a CG is deactivated, the UE may not be required perform any UL/DL transmission, but may initiate or request to initiate a CG activation.

When a CG failure is detected on a first RAN node, a CG failure recovery may be performed via the other CG on the second RAN node.

It is contemplated that corresponding to such cases, system information (SI) can be acquired on a SpCell by the UE itself, or via dedicated signaling.

Aspects for DC configuration in cases where a UE is configured with two CGs across two RAN nodes, and where either of these CGs can be activated and/or deactivated independently of the other CG are now discussed.

With respect to a CN-RAN connection, note that in some cases the 6G MR-DC can be understood to be restricted to only a 5G CN or only a 6G CN. During the DC configuration, the anchor RAN node is not changed. However, a user plane (UP) connection that exists between one of the RAN nodes and a CN-UP/user plane function (UPF) may be switched to the other RAN node as part of the procedure.

Various embodiments herein are explained in the context of a UE that goes from a pure 5G connection environment (connected to only a 5G node) to operation under a 6G MR-DC configuration (e.g., connected to each of the 5G node and a 6G node). Corresponding to such cases, it may be that a current configuration for the 5G node is assumed as a first CG (a “CG #0”) configuration. Then, the network decides to enable the 6G MR-DC configuration based on information from the UE and/or otherwise available at the network.

Information provided by the UE that is used to take the decision to enable the 6G MR-DC configuration may include a report by the UE of a UE preference for 6G cell addition. This report may include detailed information about a preferred target 6G cell (e.g., a physical cell identity (PCI) of the preferred target 6G cell, a frequency of the preferred target 6G cell, etc.).

Additionally and/or alternatively, information provided by the UE that is used to take the decision to enable the 6G MR-DC configuration may include a measurement report that contains a measurement quality of one or more 6G cells.

Then, in the Uu interface, the first node (in this example, the 5G node) provides a DC configuration that indicates a 6C CG (“CG #1”) of the 6G node within a 5G RRC reconfiguration message. Within this RRC reconfiguration message, an SRB can be explicitly configured to be via CG #0 or CG #1. Further, for security purposes, this RRC reconfiguration message may explicitly indicate a master key, which may be associated with either the first node, the second node, or which may be node agnostic.

Such configuration information may be provided in full in some cases. In other cases, a differential configuration (that is understood relative to an existing configuration) may be used signal one or more of these aspects.

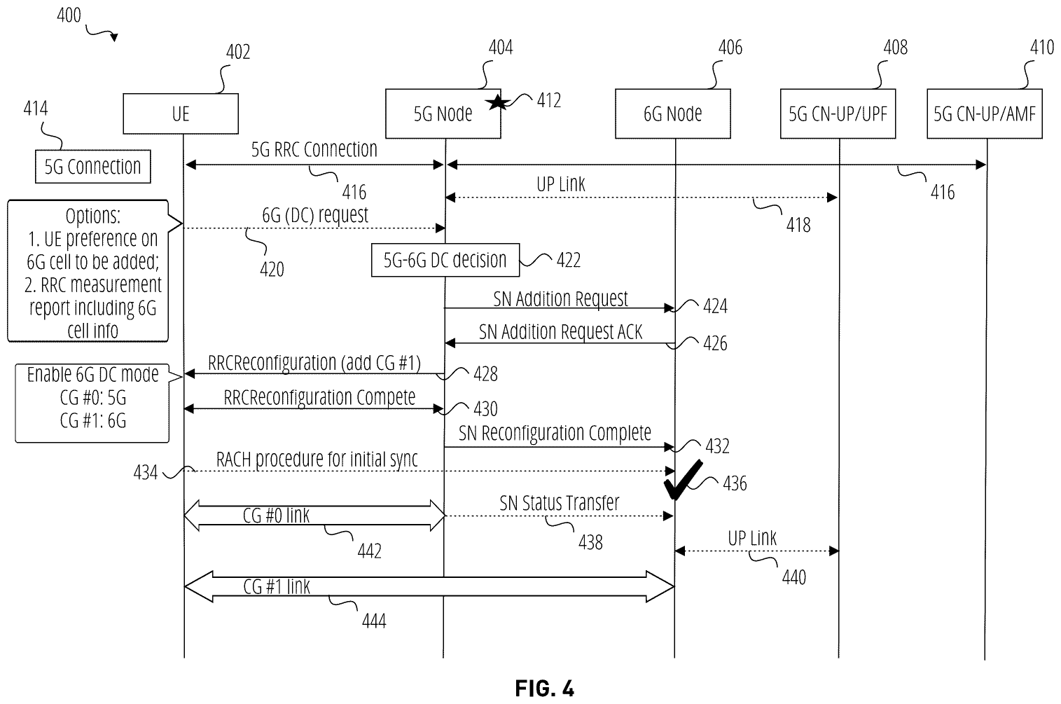

FIG. 4 illustrates a flow diagram 400 for a DC configuration procedure according to embodiments discussed herein. The flow diagram 400 illustrates communications as between a UE 402, a 5G node 404, a 6G node 406, a 5G CN-UP/UPF 408, and a 5G CN-UP/access and mobility management function (AMF) 410. As illustrated, the scenario illustrated in the flow diagram 400 takes the 5G node 404 as an anchor node 412.

The flow diagram 400 begins with the assumption that there is a 5G connection 414 between the UE 402 and the network. As part of this 5G connection 414, an RRC connection 416 exists between the UE 402 and the 5G node 404 and back to the 5G CN-UP/AMF 410. Further, as shown, there is a UP link 418 between the 5G node 404 and the 5G CN-UP/UPF 408.

The UE 402 then sends the 5G node 404 a 6G (DC) request 420. Various options exist for the contents of the 6G (DC) request 420. For example, the 6G (DC) request 420 may include an indication of a 6G cell that is preferred by the UE 402 (a preferred target cell) for addition. Additionally and/or alternatively, the 6G (DC) request 420 may include an RRC measurement report including one or more measurements of one or more 6G cells.

Based on the 6G (DC) request 420, the 5G node 404 takes a 5G-6G decision 422 that results in a determination to implement DC with the 6G node 406. The 5G-6G decision 422 may be taken based on information (e.g., preferred target cell, one or more measurements of an RRC measurement report) that was provided in the 6G (DC) request 420.

As a result of the 5G-6G decision 422 to implement DC with the 6G node 406, the 5G node 404 sends the 6G node 406 an SN addition request 424. Upon receiving the SN addition request 424, the 6G node 406 responds to the 5G node 404 with an SN addition request acknowledgement 426.

Upon receiving the SN addition request acknowledgement 426, the 5G node 404 sends the UE 402 an RRC reconfiguration message 428. The RRC reconfiguration message 428 instructs the UE 402 to enable a 6G MR-DC mode. In the context of the flow diagram 400, a “CG #0” is a 5G CG for the 5G node 404 while a “CG #1” is a 6G CG of the 6G node 406. Accordingly, the RRC reconfiguration message 428 is illustrated as instructing the UE 402 to add the 6G CG of the 6G node 406 (the “CG #1”) (e.g., in addition to its existing use of the 5G CG of the 5G node 404 (the “CG #0”)). The UE 402 applies the corresponding configuration and then replies to the 5G node 404 with the RRC reconfiguration complete message 430. In response to its receipt of the RRC reconfiguration complete message 430, the 5G node 404 sends the 6G node 406 an SN reconfiguration complete message 432 to indicate to the 6G node 406 that the UE 402 has been configured to use the 6G node 406.

The UE 402 then initiates a random access channel (RACH) procedure 434 with/on the 6G node 406, such that initial sync of the UE 402 to the 6G node 406 occurs. As a result of the RACH procedure 434, the UE 402 is connected 436 to the 6G node 406.

The 5G node 404 then sends the 6G node 406 an SN status transfer message 438. Correspondingly, the 6G node 406 establishes a user plane link 440 with the 5G CN-UP/UPF 408 for the UE 402.

At this juncture, the UE 402 is in a DC mode using each of the 5G node 404 on a CG #0 link 442 and the 6G node 406 on a CG #1 link 444.

In some embodiments corresponding to establishing 6G MR-DC for a UE, anchor node status is shifted from a 5G node to a 6G node.

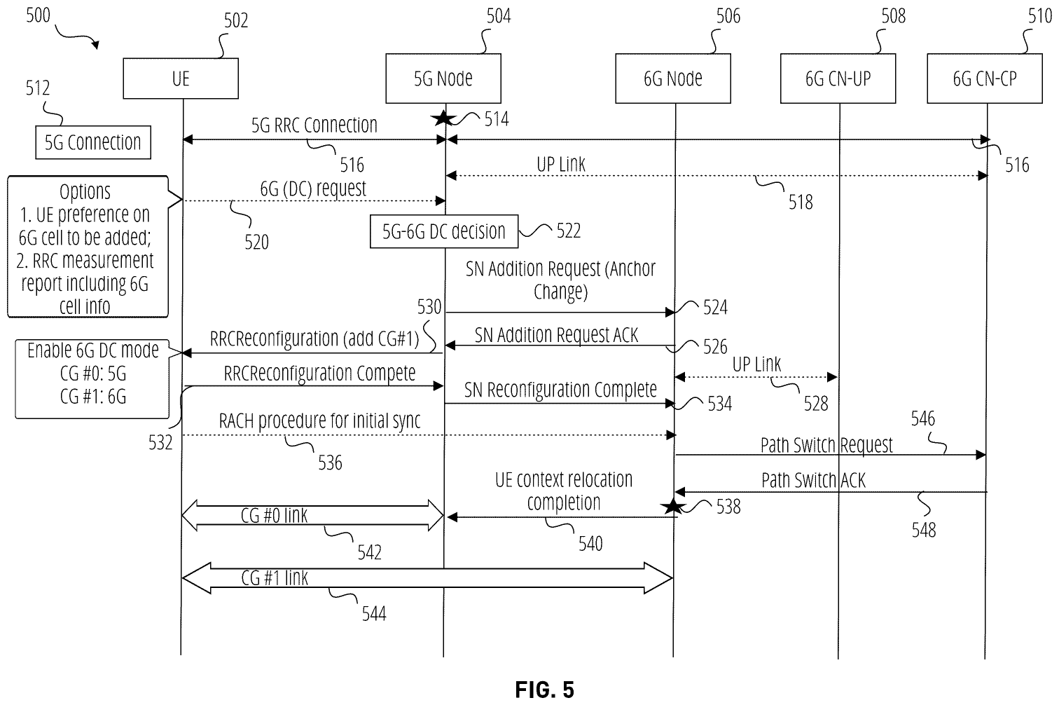

FIG. 5 illustrates a flow diagram 500 for a DC configuration procedure that shifts anchor node status from a 5G node to a 6G node, according to embodiments discussed herein. The flow diagram 500 illustrates communications as between a UE 502, a 5G node 504, a 6G node 506, a 6G CN-UP entity 508, and a 6G CN-control plane (CP) 510. As illustrated, the scenario illustrated in the flow diagram 500 initially takes the 5G node 504 as an anchor node 514.

The flow diagram 500 begins with the assumption that there is a 5G connection 512 between the UE 502 and the network. As part of this 5G connection 512, an RRC connection 516 exists between the UE 502 and the 5G node 504 and back to the 6G CN-CP entity 510. Further, as shown, there is a UP link 518 between the 5G node 504 and the 6G CN-CP entity 510.

The UE 502 then sends the 5G node 504 a 6G (DC) request 520. Various options exist for the contents of the 6G (DC) request 520. For example, the 6G (DC) request 520 may include an indication of a 6G cell that is preferred by the UE 502 (a preferred target cell) for addition. Additionally and/or alternatively, the 6G (DC) request 520 may include an RRC measurement report including one or more measurements of one or more 6G cells.

Based on the 6G (DC) request 520, the 5G node 504 takes a 5G-6G decision 522 that results in a determination to implement DC with the 6G node 506. The 5G-6G decision 522 may be taken based on information (e.g., preferred target cell, one or more measurements of an RRC measurement report) that was provided in the 6G (DC) request 520.

As a result of the 5G-6G decision 522 to implement DC with the 6G node 506, the 5G node 504 sends the 6G node 506 an SN addition request 524. The SN addition request 524 includes a request for an anchor change from the 5G node 504 to the 6G node 506 for the UE. Upon receiving the SN addition request 524, the 6G node 506 responds to the 5G node 504 with an SN addition request acknowledgement 526. Further, in response to the SN addition request 524, the 6G node 506 establishes a user plane link 528 with the 6G CN-UP entity 508 for the UE 502.

Upon receiving the SN addition request acknowledgement 526, the 5G node 504 sends the UE 502 an RRC reconfiguration message 530. The RRC reconfiguration message 530 instructs the UE 502 to enable a 6G MR-DC mode. In the context of the flow diagram 500, a “CG #0” is a 5G CG for the 5G node 504 while a “CG #1” is a 6G CG of the 6G node 506. Accordingly, the RRC reconfiguration message 530 is illustrated as instructing the UE 502 to add the 6G CG of the 6G node 506 (the “CG #1”) (e.g., in addition to its existing use of the 5G CG of the 5G node 504 (the “CG #0”)). The UE 502 applies the corresponding configuration and then replies to the 5G node 504 with the RRC reconfiguration complete message 532. In response to its receipt of the RRC reconfiguration complete message 532, the 5G node 504 sends the 6G node 506 an SN reconfiguration complete message 534 to indicate to the 6G node 506 that the UE 502 has been configured to use the 6G node 506.

The UE 502 then initiates a RACH procedure 536 with/on the 6G node 506, such that initial synchronization of the UE 502 to the 6G node 506 occurs. In response to the RACH procedure 536 with the UE 502, the 6G node 506 sends the 6G CN-CP entity 510 a path switch request message 546 that requests that the 6G node 506 take the place of the 5G node 504 as the anchor node for the UE 502. The 6G CN-CP entity 510 replies to the path switch request message 546 with a path switch acknowledgement message 548. In response to the path switch acknowledgement message 548, the 6G node 506 takes the place of the 5G node 504 as the anchor node 538 for the UE 502.

Then, the 6G node 506 sends the 5G node 504 a UE context relocation completion message 540 that indicates to the 5G node 504 that the 6G node 506 has become the anchor node 538 for the UE 502.

At this juncture, the UE 502 is in a 6G MR-DC mode using each of the 5G node 504 on a CG #0 link 542 and the 6G node 506 on a CG #1 link 544 (and with the 6G node 506 acting as the anchor node 538 of the UE 502).

Security configurations for embodiments using 6G DC (including 6G MR-DC) are now discussed. A CG-specific security mechanism may be used. In such embodiments, for a radio bearer (RB) (e.g., a signaling radio bearer (SRB)) anchored in a CG, the UE will use the security key (sometimes referred to herein as a “key”) that corresponds to that CG.

Aspects of key generation for each CG are now discussed. In a first option (“Option 1”), the key for the first GC and the key for the second GC are independent from one another. Under this option, a UE follows the provided configuration in order to derive each of these independent keys.

In a second option (“Option 2”), a key of one of the first GC and the second GC is used as a master key. Then, a key for the other of the first GC and the second GC is derived from/using this master key. Corresponding to such cases, the network may explicitly indicate which CG is the CG of the master key. Note that the master key could be provided in either the first GC or the second GC corresponding to these embodiments.

In a third option (“Option 3”), a master key is provided to the UE. Then each of a first derived key for the first GC and a second derived key for the second GC are derived from that master key. Corresponding to these cases, the master security key is not directly used for either/any CG.

Under the third option, the network explicitly indicates the master key to the UE. Then, the network explicitly indicates both a first K-counter for the first CG and a second K-counter for the second GC. The UE then derives a first derived key for the first CG by applying the first K-counter value for the first GC with the master key. The UE also derives a second derived key for the second CG by applying the K-counter value for the second GC with the master key.

Various benefits corresponding to the use of key generation under the third option are now discussed. First, it is noted that under the third option, the key generation mechanism is the same for both the first GC and the second GC.

Further, under the third option, a change to one CG will not impact the viability of the existing key for the second CG. For example, take a case where a UE is initially configured with CG #0 (e.g., on 5G) and CG #1 (e.g., on 6G), and where the UE is to move from using CG #0 to a CG #2 (e.g., on 5G). In such a case, there is no impact on the viability of the key that is used for CG #1 corresponding to this cases (and thus no transmission impact to CG #1). This is because all these keys for each GC is derived in an independent matter from the master key.

In cases where the CG change is a result of network configuration signaling, a new counter (e.g., a new K-counter) can be indicated by the network. Further, corresponding to alternative cases where the CG change is based on a UE determination, it may be that the network has preconfigured a counter list (e.g., of K-counters) for UE selection purposes. Accordingly, the UE can indicate a selected counter index for the new CG to the network in a CG reconfiguration complete message.

Table 1 illustrates a comparison between the three security key options just discussed.

TABLE 1
Security Key Configuration Options Compared

| | CG-agnostic | Key of 5G-CG | Key of 6G-CG |
|---|---|---|---|
| Option | key | (CG #0) | (CG #1) |
| Option 1 | N/A | Key #1 | Key #2 |
| Option 2 | N/A | Master key | Key Derived from |
| | | | Master key and |
| | | | K-counter |
| Option 3 | Master key | Derived from | Derived from |
| | | Master Key and | Master Key and |
| | | K-counter #1 | K-counter #2 |

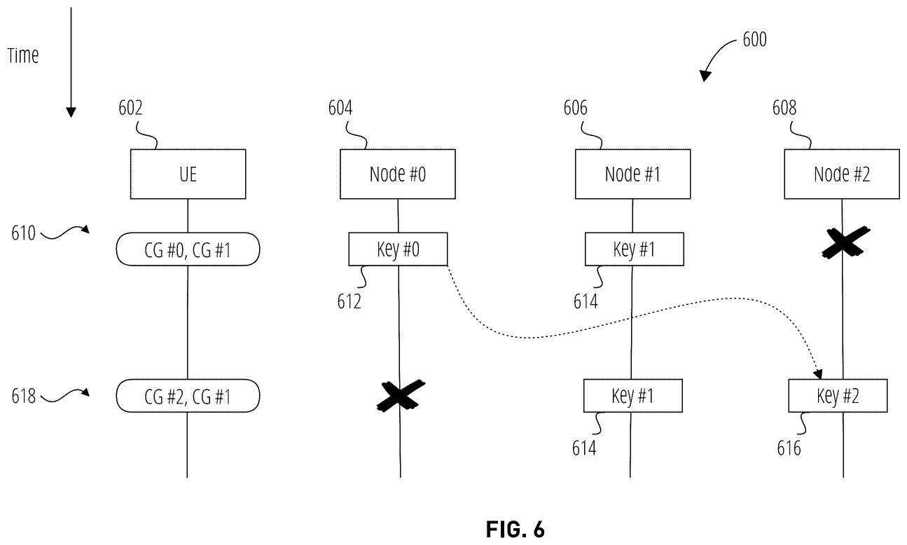

FIG. 6 illustrates a diagram 600 for a changing security key configuration at a UE 602 corresponding to a CG change. The diagram 600 illustrates security key aspects in terms of the UE 602, a node #0 604, a node #1 606, and a node #2 608. At a first time 610, the UE 602 uses a key #0 612 to communicate on the node #0 604 and a key #1 614 to communicate on the node #1 606. Then, by the second time 618, the UE 602 performs a CG change from the node #0 604 to the node #2 608. At the second time 618, the UE (still) uses the key #1 614 to communicate on the node #1 606 and uses a (new) key #2 616 to communicate on the node #2 608.

Note that in the diagram 600, the CG change from the node #0 604 to the node #2 608 does not affect the use of the key #1 614 on the node #1 606 going forward (e.g., transmission on the node #1 606 is not interrupted, at least not for any reason related to security key configuration changes for the CG change from the node #0 604 to the node #2 608). The diagram 600 may accordingly be understood to correspond to cases of Option 1 and/or Option 3 (see Table 1). Note further that the diagram 600 does not apply in cases of Option 2, where the key #0 612 is the indicated master key.

Aspects with respect to SRB design in for 6G MR-DC are now discussed. In a first option, an SRB #1 and/or an SRB #2 can be delivered via a CG #1 and a CG #2 according to a split configuration.

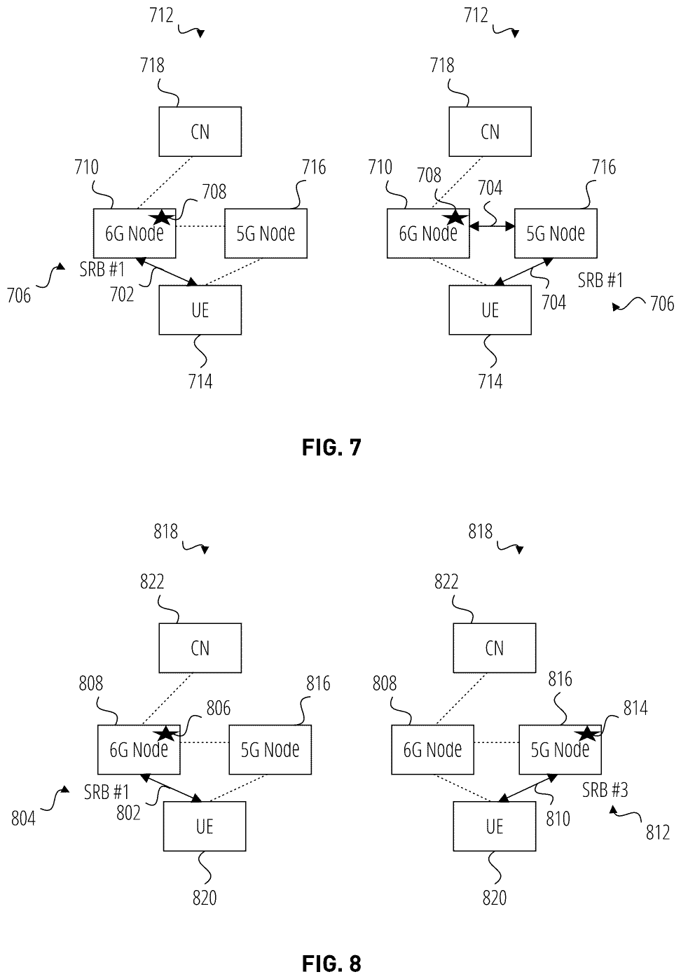

FIG. 7 illustrates a first pathing 702 and a second pathing 704 for an SRB #1 706 that is configured 708 to operate with/through a 6G node 710 according to a split configuration within a 6G MR-DC architecture 712. As illustrated, the 6G MR-DC architecture 712 includes a UE 714 that is connected to each of a 5G node 716 and the 6G node 710, with the 6G node 710 facilitating a connection to a CN 718. Note that the 6G MR-DC architecture 712 has been illustrated twice within FIG. 7 to facilitate the separate illustration of the first pathing 702 and the second pathing 704.

As illustrated, the first pathing 702 for the SRB #1 706 travels directly from the UE 714 to the 6G node 710. The second pathing 704 rather runs from the UE 714 to the 5G node 716 and then from the 5G node 716 to the 6G node 710.

In a second option for SRB design in for 6G MR-DC, different SRBs for RRC message transmission may be configured to be handled by different CG links/different RAN nodes. For example, an SRB #1 may be configured to be handled in a first CG/by a first RAN node, while an SRB #3 may be configured to be handled in a second CG/by a second RAN node. Then, the UE selects the appropriate SRB of the activated CGs for an appropriately corresponding RRC message transmission.

When both CGs are simultaneously activated for RRC message transmission, it may be that RRC messaging for one CG is prioritized over the RRC messaging for the other CG. This prioritization may be UE selected, or it may be network configured.

In various cases, the network explicitly configures association(s) between SRB(s) and particular RRC message type(s).

FIG. 8 illustrates a first pathing 802 for an SRB #1 804 that is configured 806 to operate with/through a 6G node 808 within a 6G MR-DC architecture 818 and a second pathing 810 for an SRB #3 812 that is configured 814 to operate with/through a 5G node 816 within the 6G MR-DC architecture 818. As illustrated, the 6G MR-DC architecture 818 includes a UE 820 that is connected to each of a 5G node 816 and the 6G node 808, with the 6G node 808 facilitating a connection to a CN 822. Note that the 6G MR-DC architecture 818 has been illustrated twice within FIG. 8 to facilitate the separate illustration of the first pathing 802 and the second pathing 810.

As illustrated, the first pathing 802 for the SRB #1 804 travels directly from the UE 820 to the 6G node 808. The second pathing 810 for the SRB #3 812 travels directly from the UE 820 to the 6G node 808.

Aspects of CG activation and/or deactivation within 6G MR-DC frameworks in embodiments where the first CG and the second CG may be independently activated or deactivated are now discussed. It may be that under such 6G MR-DC architectures, either CG may be activated and/or deactivated by explicit network signaling and/or by the UE.

For example, in a first option, the network uses signaling (e.g., layer 1 (L1), layer 2 (L2) and/or layer (L3) signaling) to change the state of either CG from activated to deactivated (or vice versa). Note that this may be done independently for either CG. The signaling to activate and/or deactivate one CG is transmitted via an activated CG.

In a second option for CG activation and/or deactivation within 6G MR-DC frameworks where the first CG and the second CG may be independently activated or deactivated, the UE initiates a CG activation or deactivation procedure. The UE may initiate a CG activation or deactivation (as the case may be) based on one or more conditions.

Some example conditions under the second option are CG-specific quality conditions. For example in some cases, the UE activates a CG when the quality of the CG quality meets a threshold.

In some cases, the UE deactivates a CG when the quality of the CG does not meet a threshold.

In some cases, the UE activates a CG when the quality of the CG quality meets a first threshold and when the quality of another CG (e.g., a serving CG) does not meet a second threshold. The first threshold and the second threshold may be the same or different.

In some cases, the UE deactivates a CG (e.g., a serving CG) when the quality of the CG quality does not meet a first threshold and when the quality of another CG meets a second threshold. The first threshold and the second threshold may be the same or different.

Other example conditions under the second option relate to an analysis of service/traffic that is configured for each CG. In some cases, a UE initiates a CG activation mechanism if there is a data arrival for transmission on that CG.

In some cases, a UE initiates a CG deactivation mechanism if there is no data for transmission for that CG over a period of time (e.g., over X ms (milliseconds)).

Other example conditions under the second option relate to circumstances related to UE power. In some cases, the UE may prefer and/or initiate deactivation of one or more CG(s) when the UE is power limited (e.g., cases where UE power level of the UE does not meet a threshold).

In a third option for CG activation and/or deactivation within 6G MR-DC frameworks where the first CG and the second CG may be independently activated or deactivated, the UE provides a suggestion and/or preference for CG activation and/or deactivation to the network, and the final decision for CG activation/deactivation is decided by network. Note that the UE may provide a suggestion/preference for CG activation/deactivation to the network based on, for example, any one or more of the options described in relation to the second option.

Aspects of UE operation for a deactivated CG are now discussed. When a CG is deactivated, the UE stops UL/DL transmission over that CG. Later, when the UE has UL data for transmission over that CG, the UE may initiate a scheduling request (SR) procedure directly over that deactivated CG. Alternatively, the UE may inform/request the network to activate the deactivated CG.

It is noted that the UE performs radio resource management (RRM) measurement over its serving cells when in a relaxed mode.

When a CG (e.g., CG #0) is switched to deactivated state, but there is still ongoing data in the buffer, the UE may assume/treat the data pending in the buffer as new data, and retransmit it via an activated CG (e.g., CG #1). Correspondingly, the UE may flush the current buffer (e.g., a current softbuffer, a current HARQ buffer) of CG #0.

Aspects of UE operation for an activated CG are now discussed. The UE follows its configuration and any network scheduling to perform transmission and/or measurement on a per-CG basis.

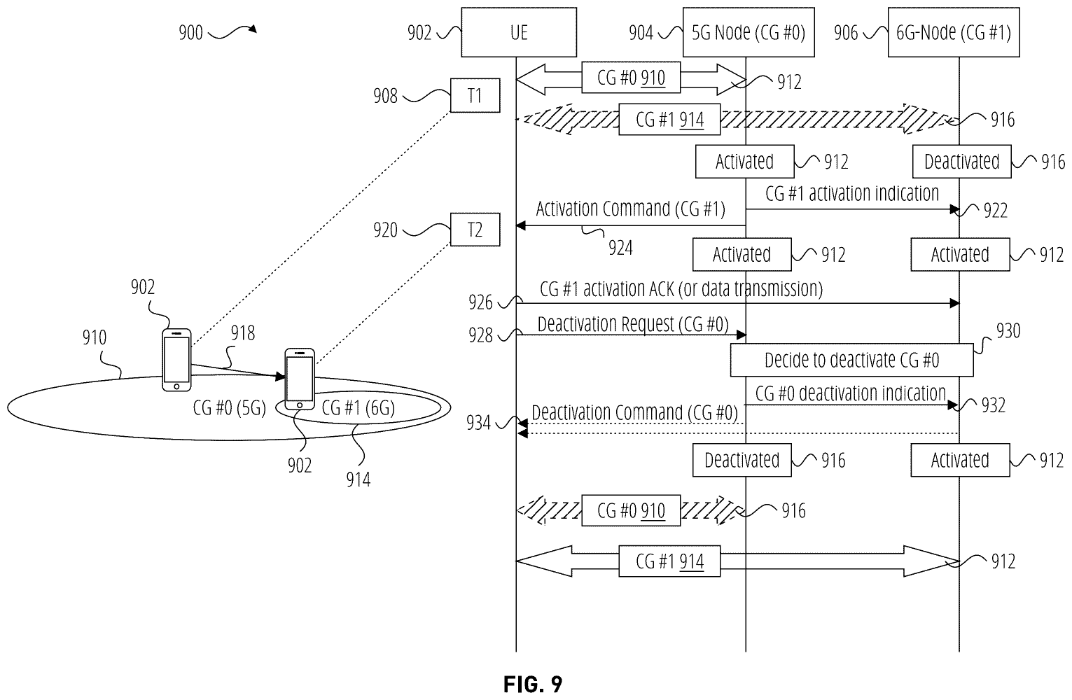

FIG. 9 illustrates a flow diagram 900 for CG activation and CG deactivation at a UE 902, according to embodiments discussed herein. The flow diagram 900 illustrates communications between the UE 902, a 5G node 904, and a 6G node 906.

A scenario corresponding to the flow diagram 900 contemplates that the network intends to provide service to the UE 902 via a 6G cell when the UE 902 is in 6G coverage. Accordingly, it is assumed that the network enables the UE to operate according to a 6G MR-DC configuration.

At a first time T1 908, the UE 102 is located within the coverage of a CG #0 910 of the 5G node 904 but outside the coverage of a CG #1 914 of the 6G node 906. Correspondingly, at the first time T1 908, the CG #0 910 is in an activated state 912 at the UE 902, while the CG #1 914 is in a deactivated state 916 at the UE 902.

Then, by a second time T2 920, the UE 902 moves 918 into coverage of the CG #1 914 of the 6G node 906. Accordingly, the network activates the CG #1 914 at the UE using a CG activation procedure. As part of this procedure, the 5G node 904 sends the 6G node 906 a CG #1 activation indication 922 that instructs the 6G node 906 to activate the CG #1 914 for the UE 902. Further, the 5G node 904 sends the UE 502 an activation command 924 that instructs the UE 902 to activate the CG #1 914. Accordingly, both the CG #0 910 of the 5G node 904 and the CG #1 914 of the 6G node 906 are in an activated state 912 at the UE, as shown. The UE 902 may provide the 6G node 906 (via the now-activated CG #1 914) a CG #1 activation acknowledgement (ACK) message 926.

The network may be capable of initiating a deactivation of the CG #0 910 of the 5G node 904 based on a UE request or based on a network trigger. The particular embodiment illustrated here is the UE-request-based case. Accordingly, The flow diagram 900 illustrates that the UE 902 sends the 5G node 904 a deactivation request 928 to deactivate the CG #0 910. In response to the deactivation request 928, the network determines 930 to deactivate the CG #0 910 as requested.

Accordingly, the 5G node 904 sends the 6G node 906 a deactivation indication 932, informing the 6G node 906 that the 5G node 904 will deactivate the CG #0 910 for the UE 902. Then, either the 5G node 904 (via the CG #0 910) or the 6G node 906 (via the CG #1 914) sends the UE 902 a deactivation command 934 that instructs the UE to deactivate the CG #0 910. The UE does so.

Accordingly, as shown, at the end of the procedure illustrated in the flow diagram 900, the CG #0 910 is in the deactivated state 916 at the UE 902, while the CG #1 914 is in the deactivated state 916 at the UE 902.

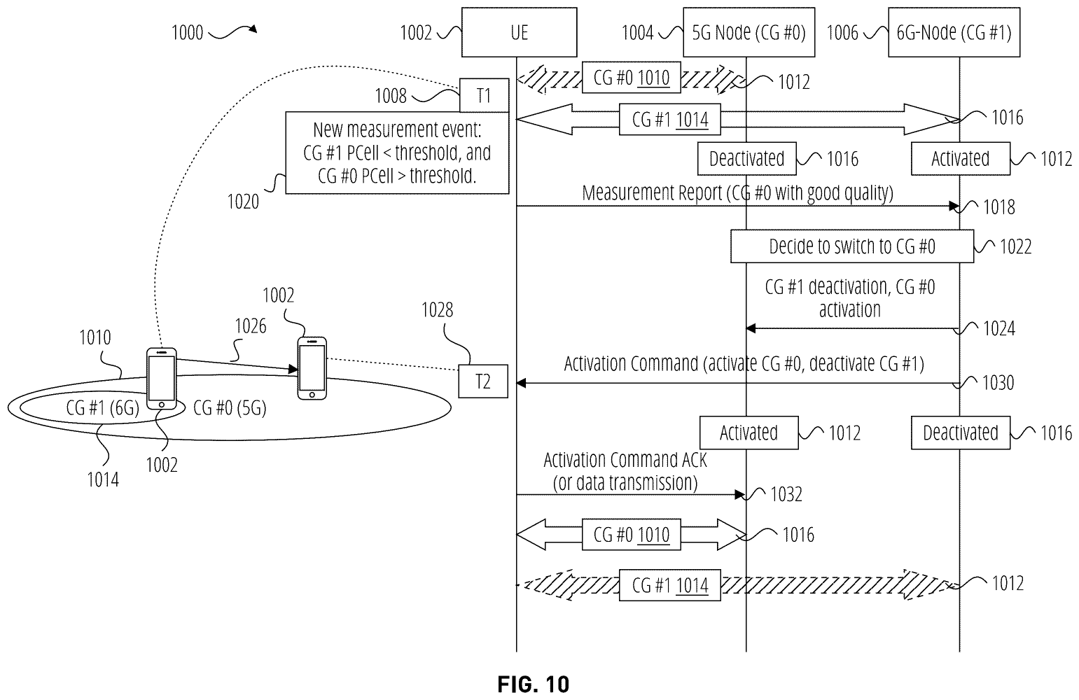

FIG. 10 illustrates a flow diagram 1000 for CG activation and CG deactivation at a UE 902, according to embodiments discussed herein. The flow diagram 1000 illustrates communications between the UE 1002, a 5G node 1004, and a 6G node 1006.

A scenario corresponding to the flow diagram 1000 contemplates that a UE 1002 that initially operates under 6G coverage of a CG #1 1014 of the 6G node 1006 moves 1026 out of the coverage of the CG #1 1014. It is anticipated that a CG #0 1010 of the 5G node 1004 that can provide coverage to the UE 1002 is to be activated in response. Accordingly, the example of the flow diagram 1000 begins with the presumption that at a first time T1 1008, the CG #0 1010 of the 5G node 1004 is deactivated at the UE 1002 and that the CG #0 1010 of the 6G node 1006 is activated for the UE.

The UE 1002 performs measurements of one or more cells (e.g., across one or more of the 5G node 1004 and/or the 6G node 1006) These measurements trigger the UE 1002 to send a measurement report 1018 to the 6G node 1006 based on a detected event drawn from those measurements.

The detected event may be understood to correspond to a case where it is desirable for the UE to transition the CG #1 1014 to the deactivated state 1016 and to further transition the CG #0 1010 to the activated state 1012. For example, the detected event may have a known or presumed correspondence to a situation where the UE 1002 moves 1026 in such a way that it exits a coverage of the CG #1 1014 (while remaining in the coverage of the CG #0 1010), as illustrated.

In the example of flow diagram 1000, the detected event corresponds to the determination the UE 1002 has measured a PCell of the CG #1 1014 as failing to meet a threshold, and that the UE 1002 has measured a PCell of the CG #0 1010 as meeting a same or different applicable threshold.

The measurement report 1018 that is sent to the 6G node 1006 may accordingly include some indication that the CG #0 1010 has been measured by the UE with a good quality.

Based on the contents of the measurement report 1018 (e.g., the indication that the CG #0 1010 has been measured with a good quality), the network determines 1022 to deactivate the CG #1 1014 for the UE 1002 and to activate the CG #0 1010 for the UE 1002.

Note that the reception of the measurement report 1018 may itself act to inform the network that a measurement event corresponding to a case where it is desirable for the UE to transition away from a currently active CG has been registered by the UE 1002. In such cases, it may not be necessary for the measurement report 1018 to include explicit information on all measurements that caused the measurement event 1020 as identified/measured by the UE 1002 For such cases, a measurement report 1018 having only an indication of a CG with good quality for the network to transition the UE 1002 to, as shown here, may be sufficient to cause the network to implement the transition of the UE 1002 to the CG #0 1010.

However, in alternative cases to those illustrated in the flow diagram 1000, a measurement report may include all measurements related to a measurement event registered by the UE to allow the network to make an independent, explicit determination to implement the transition of the UE 1002 to the CG #0 1010 (e.g., by itself registering the measurement event using the provided information).

After the network determines 1022 to switch the UE from the CG #1 1014 to the CG #0 1010, the 6G node 1006 sends an activation/deactivation indication 1024 to the 5G node 1004 that indicates that the UE 1002 will deactivate the CG #1 1014 and will further activate the CG #0 1010. In this way, the 6G node 1006 informs/prepares the 5G node 1004 to provide the CG #0 1010 in an activated state 1012 with respect to the UE 1002. The activation command 1030 may be sent a second time T2 1028 corresponding to the movement 1026 of the UE 1002 out of coverage of the CG #1 1014, as shown.

Further, the 6G node 1006 sends the UE 1002, on the CG #1 1014, an activation command 1030 that instruct the UE to deactivate the CG #1 1014 and to activate the CG #0 1010.

In response to the activation command 1030, the UE transitions the CG #1 1014 of the 6G node 1006 to the deactivated state 1016, and further transitions the CG #0 1010 of the 5G node 1004 to the activated state 1012, as shown. Then, the UE 1002 sends an activation command ACK message 1032 to the 5G node 1004 on the newly activated UE 1002. The activation command ACK message 1032 informs the network that the UE 1002 successfully received and implemented the instruction to deactivate the CG #1 1014 and to activate the CG #0 1010. In some cases, the UE 1002 may alternatively make this indication implicitly by sending data (instead of an explicit activation command ACK message 1032) on the UE 1002 of the 5G node 1004, as illustrated.

Accordingly, as shown, at the end of the procedure illustrated in the flow diagram 1000, the CG #0 1010 is in the activated state 1012 at the UE 1002, while the CG #1 1014 is in the deactivated state 1016 at the UE 1002.

Corresponding to cases for the activation/deactivation of CGs of a 6G MR-DC configuration at the UE on an individual and independent basis, there are three cases of the combinations contemplated herein. In a first case, both CGs are activated. In a second case, both CGs are deactivated. In a third case, one CG is activated while the other is deactivated.

Corresponding to scenarios where both CGs are activated, note that an RRC connection between the UE and the network is maintained by/through an activated CG. In various embodiments, a recovery of a CG failure on one CG can be performed on/over the link of the other CG. In some such cases, the UE may initiate RRC reestablishment procedures only when the links over both CGs are sufficiently poor and/or failed.

Corresponding to scenarios where one CG is activated and the other CG is deactivated, it may be that an RRC connection is maintained by/over the Uu interface of the activated CG. If a failure of the activated CG is detected, the UE may check the quality of the deactivated CG and respond accordingly. If the quality of the activated CG is good, the UE activates the deactivated CG, and initiates the a recovery procedure for the activated CG via the previously deactivated CG. However, if the quality of the deactivated CG is poor/worse than the quality of the activated CG, the UE may instead initiate an RRC reestablishment procedure and/or may try to locate another CG candidate outside of these two existing CGs for recovery.

Various options are now discussed corresponding to scenarios where both CGs are deactivated. In a first option, a UE may be/remain in a connected state (e.g., an RRC connected state). Under this first option, the UE performs measurement on both CGs. In other words, under the first option, when both CGs are in a deactivated state, UE performs RRM measurement on both CGs.

Note that a particularized measurement event and/or new requirements may be defined for circumstances when both CGs are deactivated. In some cases, the UE may be configured with a measurement event that triggers when a measured quality on each of the CGs fails to meet a threshold.

In some cases of the first option, the UE may be configured to perform relaxed serving and neighbor measurements using a longer measurement cycle when each of the CGs is deactivated.

In some cases of the first option, a new condition to initiate a neighbor measurement may be used. For example, it may be that an applicable S-measure value could be changed corresponding to an activated/deactivated state of a CG.

With respect to measurement report initiation during a phase when both CGs are deactivated and under the first option, various sub-options are possible. In a first sub-option, when an event condition is fulfilled, the UE initiates measurement reporting that can ultimately trigger an UL transmission.

In a second sub-option, the UE triggers a particular CG activation procedure in response to the fulfillment of a specific event condition that is applicable for cases where both CGs are deactivated is met. For example, the specific event condition for this case may be that a serving quality of a SpCell on each CG fails to meet a threshold.

Under the first option, when UL data arrival occurs at the UE, the UE may initiate a CG activation procedure on one CG. The CG selected for activation can be configured by network, or selected by UE. In some cases of UE selection, the UE can select the CG according to a measured SpCell serving quality. In some cases of UE selection, the UE may select a CG for activation that corresponds to/is for a service of the arrived UL data.

Under the first option, when DL data arrival occurs at the network, the network can use common signaling to wake up the UE. It may be that the UE monitors common channel (paging, or LP-WUS) on one of the two deactivated CGs to facilitate the reception of this signaling. A paging method used by the network may indicate the a new cause for the paging cause (e.g., CG activation) and a corresponding CG identifier (ID). In response, the UE activates the identified CG according to the cause information. Optionally, after receiving the CG activation indication from the side, the UE may delay initiating CG activation when there is UL data arrival at the UE.

In a second option for cases where both CGs are deactivated, the UE may be/remain in a connected state (e.g., an RRC connected state) and perform the measurements on/monitor the common channel on only one of the deactivated CGs. Corresponding to such cases where 6G MR-DC is configured with a 5G CG and a 6G CG, the UE can fallback to the 5G CG and work there (e.g., assuming a case where the 5G CG is acting as a coverage layer according to that 6G MR-DC configuration).

Behaviors under this second option may be analogous to one or more behaviors described according to the first option, but with the understanding that operations for UL data transmission and/or DL common channel monitoring as described there are only applied/used on the single CG being measured/monitored (e.g., the fallback CG).

In a third option for cases where both CGs are deactivated, the UE is in/transitions to an inactive state (e.g., an RRC inactive state) and stores configuration information for each of the CGs. Under this third option, the UE does not perform the measurement of any CG according to any connected (e.g., RRC connected) configuration. In such cases, it may be that the UE falls back to one CG of the two CGs and operates to on that CG's SpCell to perform measurement and/or mobility operations according to an inactive state (e.g., an RRC inactive state) there.

Embodiments for UEs Configured with Two CGs Across Two RAN Nodes, where Only One CG can be Activated at a Time

Embodiments for UEs configured with two CGs across two RAN nodes and where only one CG can be activated at a time are now discussed.

Note preliminarily that under 5G MR-DC, a UE is required to support simultaneous Rx/Tx operation on both an MCG and an SCG. Corresponding to embodiments herein for 6G MR-DC, this requirement is not applicable.

In various embodiments, the network only activates at most one CG of a 6G MR-DC configuration a time. Corresponding to cases for the activation of only one CG of a 6G MR-DC configuration at the UE at a time, there are two cases of the combinations contemplated herein.

In a first case, both CGs are deactivated. In a second case, one CG is activated while the other is deactivated.

Corresponding to cases where one CG is activated and the other CG is deactivated, it may be that an RRC connection is maintained by/over the Uu interface of the activated CG. If a failure of the activated CG is detected, the UE may check the quality of the deactivated CG and respond accordingly. If the quality of the activated CG is good, the UE activates the deactivated CG. The UE may further initiate the a recovery procedure for the activated CG via the previously deactivated CG in some of these cases. However, if the quality of the deactivated CG is poor/worse than the quality of the activated CG, the UE may instead initiate an RRC reestablishment procedure and/or may try to locate another CG candidate outside of these two existing CGs for recovery.

Various options are now discussed corresponding to cases where both CGs are deactivated. In a first option, a UE may be/remain in a connected state (e.g., an RRC connected state). Under this first option, the UE performs measurement on both CGs. In other words, under the first option, when both CGs are in a deactivated state, UE performs RRM measurement on both CGs.

Note that a particularized measurement event and/or new requirements may be defined for circumstances when both CGs are deactivated. In some cases, the UE may be configured with a measurement event that triggers when a measured quality on each of the CGs fails to meet a threshold.

In some cases of the first option, the UE may be configured to perform relaxed serving and neighbor measurements using a longer measurement cycle when each of the CGs is deactivated.

In some cases of the first option, a new condition to initiate a neighbor measurement may be used. For example, it may be that an applicable S-measure value could be changed corresponding to an activated/deactivated state of a CG.

With respect to measurement report initiation during a phase when both CGs are deactivated and under the first option, various sub-options are possible. In a first sub-option, when an event condition is fulfilled, the UE initiates measurement reporting that can ultimately trigger an UL transmission.

In a second sub-option, the UE triggers a particular CG activation procedure in response to the fulfillment of a specific event condition that is applicable for cases where both CGs are deactivated. For example, the specific event condition for this case may be that a serving quality of a SpCell on each CG fails to meet a threshold.

Under the first option, when UL data arrival occurs at the UE, the UE may initiate a CG activation procedure on one CG. The CG selected for activation can be configured by network, or selected by UE. In some cases of UE selection, the UE can select the CG according to a measured SpCell serving quality. In some cases of UE selection, the UE may select a CG for activation that corresponds to/is for a service of the arrived UL data.

Under the first option, when DL data arrival occurs at the network, the network can use common signaling to wake up UE. It may be that the UE monitors common channel (paging, or LP-WUS) on one of the two deactivated CGs to facilitate the reception of this signaling. A paging method used by the network may indicate the a new cause for the paging cause (e.g., CG activation) and a corresponding CG identifier (ID). In response, the UE activates the identified CG according to the cause information. Optionally, after receiving the CG activation indication from the side, the UE may delay initiating CG activation when there is UL data arrival at the UE.

In a second option for cases where both CGs are deactivated, the UE may be/remain in a connected state (e.g., an RRC connected state), and perform measurements on/monitor the common channel on only one of the deactivated CGs. Corresponding to such cases where 6G MR-DC is configured with a 5G CG and a 6G CG, the UE can fallback to the 5G CG and work there (e.g., assuming a case where the 5G CG is acting as a coverage layer according to that 6G MR-DC configuration).

Behaviors under this second option may be analogous to one or more behaviors described according to the first option, but with the understanding that operations for UL data transmission and/or DL common channel monitoring as described there are only applied/used on the single CG being measured/monitored (e.g., the fallback CG).

In a third option for cases where both CGs are deactivated, the UE is in/transitions to an inactive state (e.g., an RRC inactive state) and stores configuration information for each of the CGs. Under this third option, the UE does not perform the measurements of any CG according to any connected (e.g., RRC connected) configuration. In such cases, it may be that the UE falls back to one CG of the two CGs and operates to on that CG's SpCell to perform measurement and/or mobility operations according to an inactive state (e.g., an RRC inactive state) there.

Aspects of UE operation for case where a UE is configured with two CGs and where at most one CG is activated, are now discussed. In such cases, when a new CG is activated at the UE, the other CG is deactivated (either explicitly or implicitly). The UE maintains its RRC connection via the activated CG. The UE may use UE-specific configuration and scheduling information for the activated CG to perform data transmission and/or reception over the activated CG. The UE follows the measurement configurations for each of the activated CG and the deactivated CG to perform corresponding measurement of those CGs according to CG state.

In cases where a data radio bearer (DRB) is configured across both CGs, when one CG is deactivated, the UE suspends/deactivates the link for data transmission.

Aspects of network operation for a case where a UE is configured with two CGs and where at most one CG is activated are now discussed. In such cases, the network does not necessarily implement coordination between the CGs when providing the configuration and scheduling information across both CGs.

There may be embodiments that allow for only one activated CG at a time where there is further no support for a case where both CGs are in a deactivated state. Various options exist for these embodiments. In a first option, the network can indicate to the UE which CG is activated when it provides the UE with a the 6G MR-DC configuration.

In a second option, the network can explicitly transmit CG activation commands with a CG ID for an activated CG to the UE.

In a third option, the UE can initiate a CG activation by itself based on a condition. In some cases, the condition may be that there is some traffic that can only be performed via the deactivated CG. In some cases, the condition may be that the quality of the activated CG has become worse than a threshold and/or than that of the deactivated CG, or failure is detected on the activated CG. In some cases, the condition may be based on the UE power situation (e.g., that the UE power level fails to meet a corresponding threshold). In some cases, the condition may be based on UE preference. In some cases, the condition is based on minimum key performance indicators (KPIs) for the CG, a service demand for the CG, and/or QoS requirements for data to be sent as compared to a level of service achievable on the CG.

In cases of this third option where the UE itself initiates CG activation, various sub-options are possible. In a first sub-option, the UE directly sends a UL transmission via the deactivated CG (e.g., via RACH) to activate the CG. In a second sub-option, the UE sends a preference for CG activation of the deactivated CG via the currently activated CG, and waits for the network to provide an explicit CG activation command corresponding to the indicated preference.

A pair of options for maintenance of an L2 context/L2-related variables for embodiments that allow for only one activated CG at a time (and, where, e.g., there is further no support for a case where both CGs are in a deactivated state) are now discussed. In a first option, the UE can keep a separate L2 context/separate L2 variables for each CG. In a second option, the same L2 context/the same L2-related variables used for each CG.

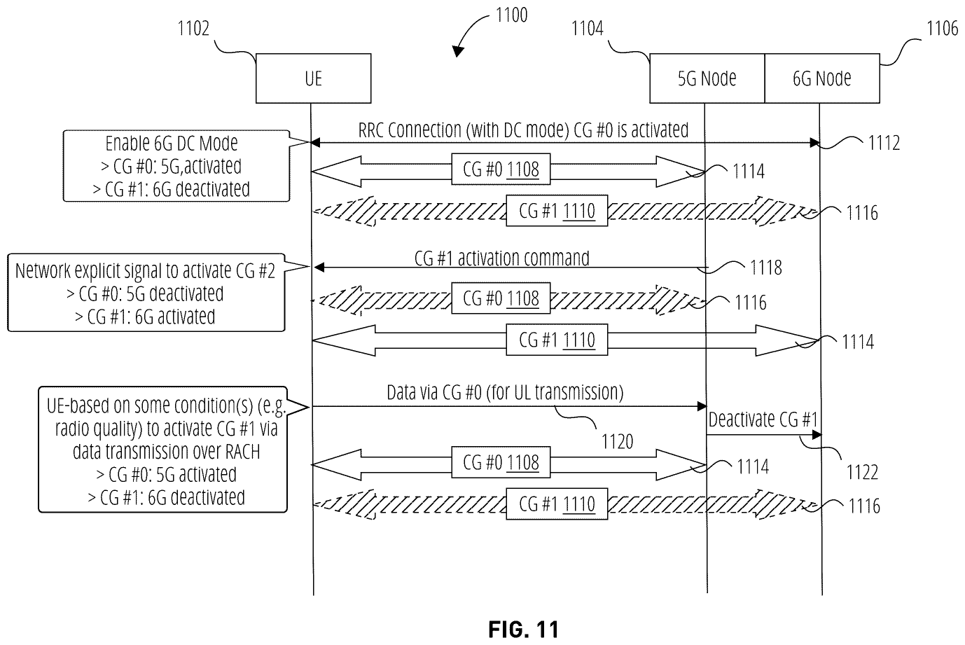

FIG. 11 illustrates a flow diagram 1100 for CG activation and CG deactivation at a UE 1102, according to embodiments discussed herein. The flow diagram 1100 illustrates communications between the UE 1102, a 5G node 1104, and a 6G node 112. The flow diagram 1100 takes a case where the UE 1102 is configured to use a 6G MR-DC mode with a CG #0 1108 on the 5G node 1104 and a CG #1 1110 on the 6G node 1106. Note that the case for the flow diagram 1100 corresponds to a case where only one CG of the 6G MR-DC configuration is activated at a time.

There is an RRC connection 1112 established between the UE 1102 and the network. Initially, the CG #0 1108 is in an activated state 1114, while the CG #1 1110 is in a deactivated state 1116, as illustrated.

Then, the 5G node 1104 sends the UE 1102 an activation command 1118 that instructs the UE 1102 to activate the CG #1 1110. Accordingly, the UE 1102 activates the CG #1 1110 as instructed. Further, the UE flow diagram 1100 also deactivates the CG #0 1108 in response to this message (because only one CG can be activated at a time). Accordingly, after the activation command 1118, the CG #0 1108 is in the deactivated state 1116 and the CG #1 1110 is in the activated state 1114, as shown.

At some later time, the UE 1102 identifies that a condition for activating the CG #0 1108 is met (e.g., a radio quality condition based on measurements of the CG #0 1108 and/or the CG #1 1110 for activating the CG #0 1108 has been met). Accordingly, the UE 1102 determines to activate the CG #0 1108 and to deactivate the CG #1 1110. To accomplish this, the UE 1102 sends the 5G node 1104 a data transmission 1120 (e.g., via RACH) on to the CG #0 1108 (which is presently in the deactivated state 1116 from the perspective of the network). Upon receiving this message, the 5G node 1104 understands that the UE 1102 is now using the CG #0 1108 in the activated state 1114. Accordingly, the 5G node 1104 begins treating the CG #0 1108 as if it is in the activated state 1114 as well. Further, because only one CG can be activated at a time, the 5G node 1104 sends the 6G node 1106 a deactivation command 1122, instructing the 6G node 1106 to treat the CG #1 1110 as deactivated going forward. Accordingly, after the deactivation command 1122 is sent, the CG #0 1108 is in the activated state 1114 and the CG #1 1110 is in the deactivated state 1116, as shown.

Embodiments for UEs Configured with Only One CG at a Time

Embodiments for UEs configured with only one CG at a time are now discussed. Corresponding to these embodiments, a switch between two CGs is carried out via an RRC configuration. This is done without a CN change and without necessarily changing anchor node(s).

In some of these embodiments, a connection between a UE and an anchor CN node can be maintained via 5G-RAT or 6G-RAT according to one of two possible modes. In a first of these modes, the UE is configured with a 6G-RAT CG in a Uu interface. In a second of these modes, the UE is configured with a 5G-RAT CG in a Uu interface.

Aspects of network side functionalities when a 6G anchor node (in the RAN) provides the connection to the anchor CN node are now discussed. In such cases, when a UE is configured with a 6G-RAT CG, the 6G node provides transmissions to the UE directly. When the UE is alternatively configured with a 5G-RAT CG, the 6G node (as anchor node) forwards data to the 5G node, and the 5G node provides the data to UE. Note that the 6G node is still the anchor RAN node in these circumstances.

Any switch between a 5G-RAT CG and a 6G-RAT CG occurs via RRC configuration, and without necessarily initiating an anchor CN node change. In the CP, the UE is not required to perform a handover/a key change procedure. In the UP, if network does not want to change the RAN anchor, the RAN anchor node can be kept at (assuming the preceding example) the 6G node (e.g., sited at a packet data converged protocol (PDCP) layer of the 6G node), and data transmission can be continued during the CG switching.

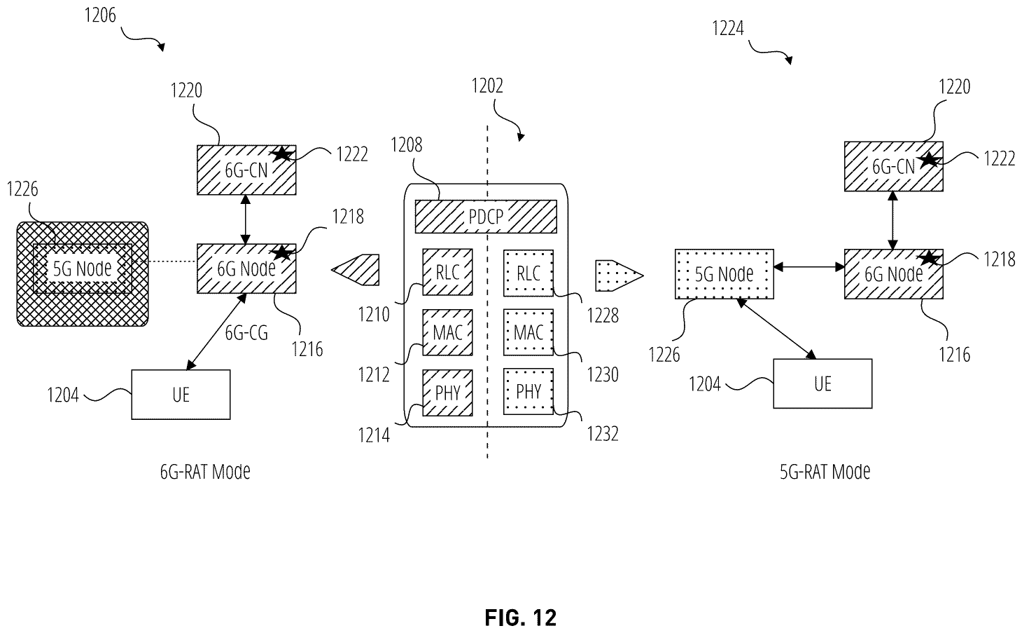

FIG. 12 illustrates a protocol stack model 1202 used to discuss a case where a UE 1204 is configured with only one CG at a time. The protocol stack model 1202 illustrates that, corresponding to a 6G-RAT mode 1206, a 6G PDCP entity 1208, a 6G RLC entity 1210, a 6G MAC entity 1212, and a 6G PHY entity 1214 are configured. The UE 1204 is connected to a 6G node 1216 that acts as an anchor RAN node 1218 for the UE 1204. The 6G node 1216 is connected to a 6G CN node 1220 which acts as an anchor CN node 1222 for the UE 1204.

While in the 6G-RAT mode 1206, the UE 1204 communicates with the 6G node 1216 directly. The 6G node 1216 in turn provides the system access to the 6G CN node 1220. An existing 5G node 1226 is not involved in communications while the 6G-RAT mode 1206 is operative, as shown.

The protocol stack model 1202 further illustrates that, corresponding to a 5G-RAT mode 1224, the 6G PDCP entity 1208, a 5G RLC entity 1228, a 5G MAC entity 1230, and a 5G PHY entity 1232 are configured. The UE 1204 is connected to the 5G node 1226, while it is the 6G node 1216 that acts as the anchor RAN node 1218 for the UE 1204. The 6G node 1216 is connected to the 6G CN node 1220 which acts as an anchor CN node 1222 for the UE 1204.

While in the 5G-RAT mode 1224, the UE ultimately communicates with the 6G node 1216 through a connection to the 5G node 1226 (the 5G node 1226 is a go-between entity for communications between the UE 1204 and the 6G node 1216). The 6G node 1216 in turn provides the system access to the 6G CN node 1220.

Multiple options for RRC configurations for embodiments where a UE is configured with only one CG at a time are now discussed. In a first option, the one CG configuration may be provided to the UE without any corresponding CG ID. The UE applies that RRC configuration accordingly.

Note that under the first option, when the network provides the UE with a configuration over a 5G-RAT, the UE will release a previous configuration over a 6G-RAT. Note that in such cases, it may be that the radio bearer uses a common configuration, and thus is not impacted by the changing CG configuration.

Similarly, when the network provides the UE with a configuration over a 6G-RAT, the UE will release a previous configuration over a 5G-RAT.

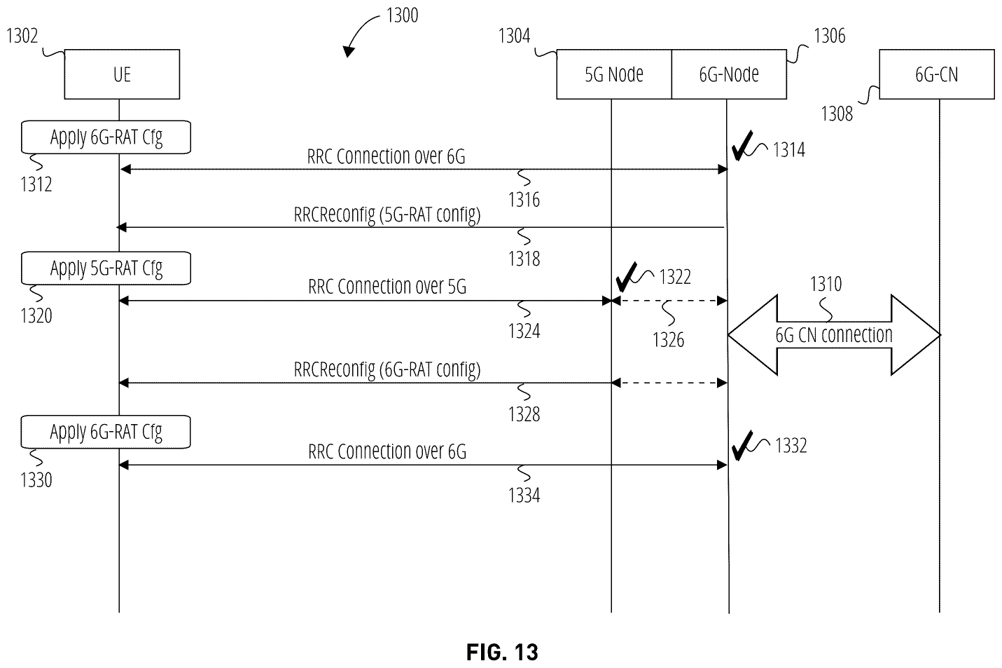

FIG. 13 illustrates an a flow diagram 1300 implementing the first option for RRC configuration when a UE is configured with only one CG at a time. The flow diagram 1300 illustrates communications between a UE 1302, a 5G node 1304, a 6G node 1306, and a 6G-CN 1308. Preliminarily, note that, as a general matter, there is a 6G CN connection 1310 between the 6G node 1306 and the 6G-CN 1308.

The UE 1302 applies 1312 a 6G-RAT configuration, thereby connecting to the 6G node 1306. This establishes 1314 an RRC connection over 6G 1316 between the UE 1302 and the 6G node 1306. Note that a connection back to the 6G-CN 1308 is ultimately achieved in this instance over the 6G CN connection 1310 between the 6G node 1306 and the 6G-CN 1308.

At a later time, the 6G node 1306 sends the UE 1302 an RRC reconfiguration message 1318 that provides the UE with a 5G-RAT configuration for use. The UE 1302 applies 1320 this 5G-RAT configuration when it is received, thereby connecting to the 5G node 1304. This establishes 1322 an RRC connection over 5G 1324 between the UE 1302 and 5G node 1304. Note that a connection back to the 6G-CN 1308 is ultimately achieved in this instance over an interface 1326 between the 5G node 1304 and the 6G node 1306 and then over the 6G CN connection 1310 between the 6G node 1306 and the 6G-CN 1308.

At a later time, the 5G node 1304 then sends the UE 1302 an RRC reconfiguration message 1328 that provides the UE with a 6G-RAT configuration for use. The UE 1302 applies 1330 this 6G-RAT configuration when it is received, thereby connecting to the 6G node 1306. This establishes 1332 an RRC connection over 6G 1334 between the UE 1302 and the 6G node 1306. Note that a connection back to the 6G-CN 1308 is ultimately achieved in this instance over the 6G CN connection 1310 between the 6G node 1306 and the 6G-CN 1308.

In a second option for RRC configurations for embodiments where a UE is configured with only one CG at a time, the network provides the UE with one CG configuration along with a corresponding CG ID. In this case, the UE may maintain/store the configuration as indexed with the provided CG ID.

In some cases under the second option, any subsequently-provided CG configurations (with different IDs) could be provided in full in a similar manner.

In some cases under the second option, once the UE has stored at least one CG configuration corresponding to a first ID, any subsequently provided CG configuration having a different ID may be provided by the network to the UE in terms of delta values/a differential manner for the UE to apply to that previously provided CG configuration.

In some cases under the second option when the UE receives a new CG configuration, it stores the previous CG and applies the newly received CG configuration.

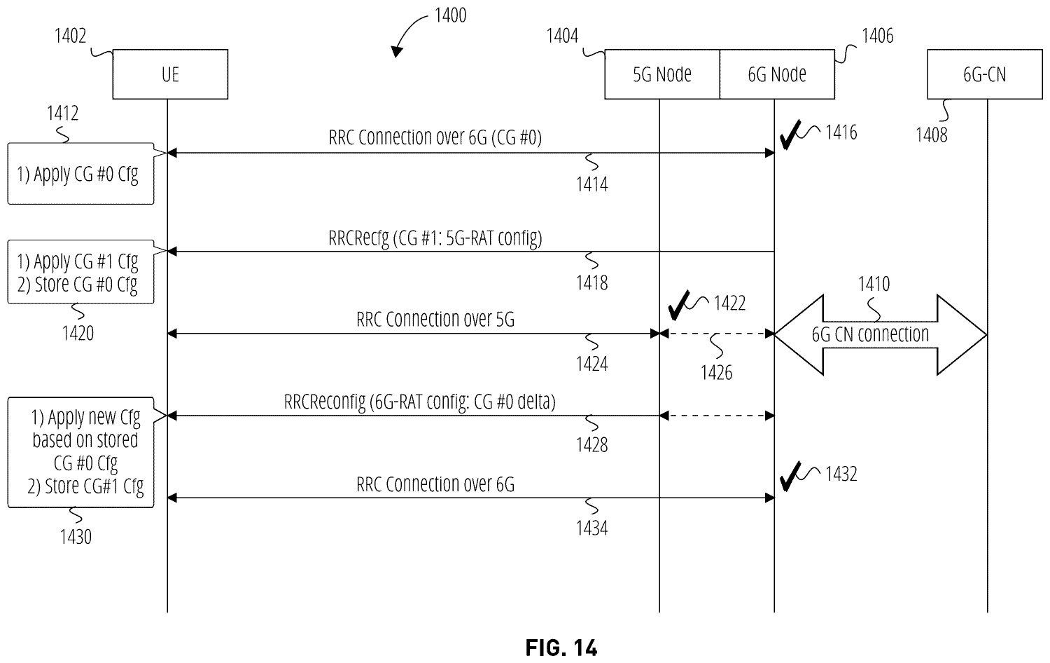

FIG. 14 illustrates an a flow diagram 1400 implementing the second option for RRC configuration when a UE is configured with only one CG at a time. The flow diagram 1400 illustrates communications between a UE 1402, a 5G node 1404, a 6G node 1406, and a 6G-CN 1408. Preliminarily, note that, as a general matter, there is a 6G CN connection 1410 between the 6G node 1406 and the 6G-CN 1408.

The UE 1402 applies 1412 a 6G-RAT configuration for a CG #0 of the 6G node 1406, thereby connecting to the 6G node 1406. This establishes 1416 an RRC connection over 6G 1414 between the UE 1402 and the 6G node 1406. Note that a connection back to the 6G-CN 1408 is ultimately achieved in this instance over the 6G CN connection 1410 between the 6G node 1406 and the 6G-CN 1408. The UE 1402 may consider this 6G-RAT configuration as a default configuration.

Then, the 6G node 1406 sends the UE 1402 an RRC reconfiguration message 1418 that includes a 5G-RAT configuration for a CG #1 of the 5G node 1404. When UE receives this RRC reconfiguration message 1418, it stores the prior CG #0 configuration and applies 1420 the new CG #1 configuration for transmission. This establishes 1422 an RRC connection over 5G 1424 between the UE 1402 and the 5G node 1404. Note that a connection back to the 6G-CN 1408 is ultimately achieved in this instance over an interface 1426 between the 5G node 1404 and the 6G node 1406 and then over the 6G CN connection 1410 between the 6G node 1406 and the 6G-CN 1408.

The 5G node 1404 then sends the UE 1402 an RRC reconfiguration message 1428 that provides the UE with a 6G-RAT config that is expressed in terms of delta values/in a differential manner with respect to the previously saved CG #0 configuration. When the UE 1402 receives the RRC reconfiguration message 1428, stores the prior CG #1 configuration and applies 1430 the new configuration by adjusting the values of the previously stored CG #0 configuration according to the delta values/differential information. This establishes 1432 an RRC connection over 6G 1434 between the UE 1402 and the 6G node 1406. Note that a connection back to the 6G-CN 1408 is ultimately achieved in this instance over the 6G CN connection 1410 between the 6G node 1406 and the 6G-CN 1408.

In a third option for RRC configurations for embodiments where a UE is configured with only one CG at a time, the network provides the UE with multiple CG configurations, and indicates to the UE which CG configuration is to currently be applied as an (active) configuration at the UE. The UE stores all the received CG configurations. The UE applies the indicated CG configuration. The remaining CG configurations are stored as candidate CG configurations.

In some cases under the third option, the UE may select a CG configuration from the set of candidate CG configurations and apply it when a condition is met. In some cases, condition may be that the network explicitly indicates a CG configuration index for one of the candidate CG configurations that is to be applied. In some cases, the condition may correspond to the occurrence of an event (e.g., such as of a measurement event like that used as a condition for a conditional handover (CHO)).

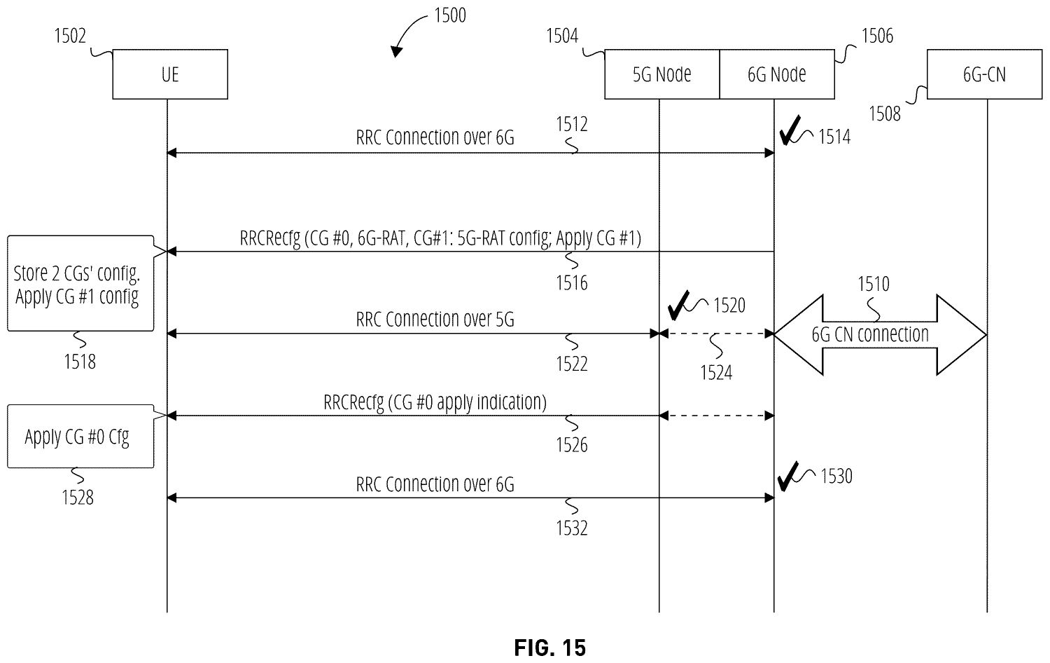

FIG. 15 illustrates an a flow diagram 1500 implementing the third option for RRC configuration when a UE is configured with only one CG at a time. The flow diagram 1500 illustrates communications between a UE 1502, a 5G node 1504, a 6G node 1506, and a 6G-CN 1508. Preliminarily, note that, as a general matter, there is a 6G CN connection 1510 between the 6G node 1506 and the 6G-CN 1508.

The UE 1402 is initially connected to the 6G node 1406 whereby an RRC connection over 6G 1512 between the UE 1502 and the 6G node 1506 is established 1514.

Then, the 6G node 1506 sends the UE 1502 an RRC reconfiguration message 1516 that includes two candidate CG configurations (a 6G-RAT configuration for a CG #0 of the 6G node 1506 and a 5G-RAT configuration for a CG #1 of the 5G node 1504). The RRC reconfiguration message 1516 further includes an instruction/indication for the UE to apply the CG #1 configuration for the 5G node 1504.

Upon receiving the RRC reconfiguration message 1516, the UE stores 1518 both candidate CG configurations, and applies the CG #1 configuration as instructed. This establishes 1520 an RRC connection over 5G 1522 between the UE 1502 and the 6G 5G node 1504. Note that a connection back to the 6G-CN 1508 is ultimately achieved in this instance over an interface 1524 between the 5G node 1504 and the 6G node 1506 and then over the 6G CN connection 1510 between the 6G node 1506 and the 6G-CN 1508. At a later time, the 5G node 1504 then sends the UE 1502 an RRC

reconfiguration message 1526 that instructs the UE to apply the configuration for the CG #0 that was previously provided to the UE. The UE 1502 accordingly applies 1528 the CG #0 configuration. This establishes 1530 an RRC connection over 6G 1532 between the UE 1502 and the 6G node 1506. Note that a connection back to the 6G-CN 1508 is ultimately achieved in this instance over the 6G CN connection 1510 between the 6G node 1506 and the 6G-CN 1508.

### Additional Example Embodiments

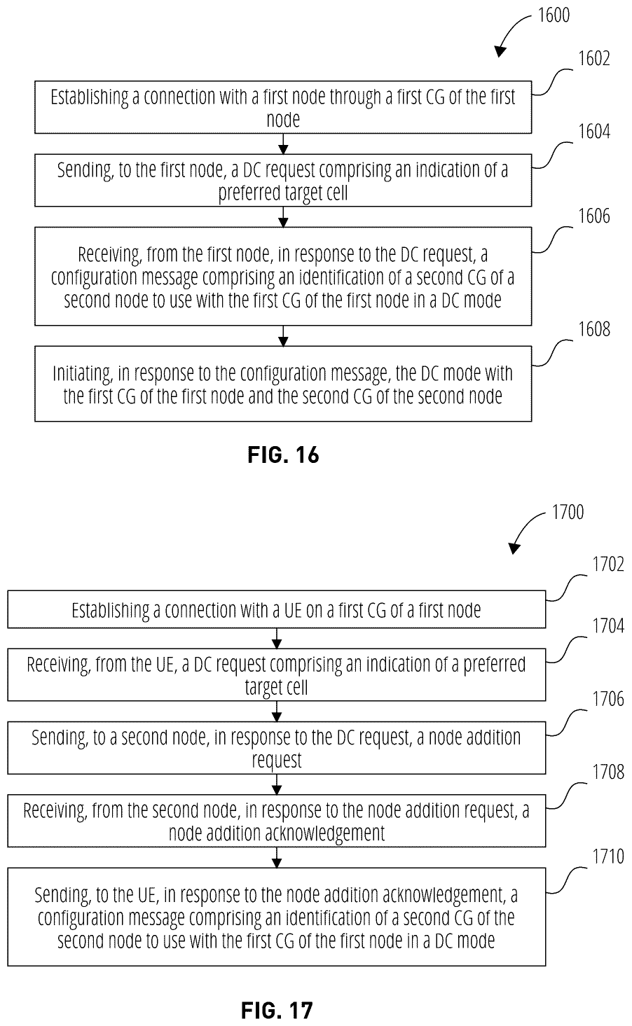

FIG. 16 illustrates a method 1600 of a UE, according to embodiments discussed herein. The method 1600 includes establishing 1602 a connection with a first node through a first CG of the first node. The method 1600 further includes sending 1604, to the first node, a DC request comprising an indication of a preferred target cell. The method 1600 further includes receiving 1606, from the first node, in response to the DC request, a configuration message comprising an identification of a second CG of a second node to use with the first CG of the first node in a DC mode. The method 1600 further includes initiating 1608, in response to the configuration message, the DC mode with the first CG of the first node and the second CG of the second node.

In some embodiments of the method 1600, the first node comprises a 5G node and the first CG comprises a 5G CG; and the second node comprises a 6G node and the second CG comprises a 6G CG.

In some embodiments of the method 1600, the first node comprises a first 6G node and the first CG comprises a first 6G CG; and the second node comprises a second 6G node and the second CG comprises a second 6G CG.

In some embodiments of the method 1600, the second CG for the second node comprises the preferred target cell.

In some embodiments of the method 1600, the DC request further comprises a measurement of a measured cell of the second node.

In some embodiments of the method 1600, the first CG comprises a plurality of cells served by the first node.

In some embodiments of the method 1600, the second CG comprises a plurality of cells served by the second node.

In some embodiments, the method 1600 further includes receiving, from one of the first node and the second node, a master key and an indication of an indicated CG of the first CG and the second CG for which to use the master key; and generating a derived key for use with a non-indicated CG of the first CG and the second CG based on the master key; and while the UE is in the DC mode: performing a first communication on the indicated CG using the master key; and performing a second communication on the non-indicated CG using the derived key.

In some embodiments, the method 1600 further includes receiving, from one of the first node and the second node, a master key, a first K-counter for the first CG, and a second K-counter for the second CG; generating a first derived key for use with the first CG based on the master key and the first K-counter; and generating a second derived key for use with the second CG based on the master key and the second K-counter; and while the UE is in the DC mode: performing a first communication on the first CG using the first derived key; and performing a second communication on the second CG using the second derived key.

In some embodiments, the method 1600 further includes, while the UE is in the DC mode: communicating over the first CG at a first time at which the first CG is activated and the second CG is deactivated; and communicating over the second CG at a second time at which the first CG is deactivated and the second CG is activated.

In some embodiments, the method 1600 further includes, while the UE is in the DC mode: determining, while the first CG is active and the second CG is inactive, that a measurement quality of the second CG meets a threshold; and initiating, in response to determining that the measurement quality of the second CG meets the threshold, an activation of the second CG and a deactivation of the first CG.

In some embodiments, the method 1600 further includes while the UE is in the DC mode: determining, while the first CG is active and the second CG is inactive, that a measurement quality of the first CG does not meet a threshold; and initiating, in response to determining that the measurement quality of the first CG does not meet the threshold, an activation of the second CG and a deactivation of the first CG.

In some embodiments, the method 1600 further includes, while the UE is in the DC mode: determining, while the first CG is active and the second CG is inactive, that a first measurement quality of the first CG does not meet a threshold and that a second measurement quality of the second CG meets the threshold; and initiating, in response to determining that the first measurement quality of the first CG does not meet the threshold and that the second measurement quality of the second CG meets the threshold, an activation of the second CG and a deactivation of the first CG.

In some embodiments, the method 1600 further includes receiving configuration information indicating that traffic of a configured traffic type is to be communicated through the first CG; and while the UE is in the DC mode: identifying, while the first CG is deactivated, that the UE is to transmit the traffic of the configured traffic type; and initiating, in response to determining that the UE is to transmit the traffic of the configured traffic type, an activation of the first CG.

In some embodiments, the method 1600 further includes receiving configuration information indicating that traffic of a configured traffic type is to be communicated through the first CG; and while the UE is in the DC mode: identifying, while the first CG is activated, that there has been no traffic of the configured traffic type during a time period; and initiating, in response to determining that there has been no traffic of the configured traffic type during the time period, a deactivation of the first CG.

In some embodiments, the method 1600 further includes, while the UE is in the DC mode: identifying, while the first CG is activated, that a power level of the UE does not meet a threshold; and initiating, in response to determining that the power level of the UE does not meet the threshold, a deactivation of the first CG.

FIG. 17 illustrates a method 1700 of a first node, according to embodiments discussed herein. The method 1700 includes establishing 1702 a connection with a UE on a first CG of the first node. The method 1700 further includes receiving 1704, from the UE, a DC request comprising an indication of a preferred target cell. The method 1700 further includes sending 1706, to a second node, in response to the DC request, a node addition request. The method 1700 further includes receiving 1708, from the second node, in response to the node addition request, a node addition acknowledgement. The method 1700 further includes sending 1710, to the UE, in response to the node addition acknowledgement, a configuration message comprising an identification of a second CG of the second node to use with the first CG of the first node in a DC mode.

In some embodiments of the method 1700, the first node comprises a 5G node and the first CG comprises a 5G CG; and the second node comprises a 6G node and the second CG comprises a 6G CG.

In some embodiments of the method 1700, the first node comprises a first 6G node and the first CG comprises a first 6G CG; and the second node comprises a second 6G node and the second CG comprises a second 6G CG.

In some embodiments, the method 1700 further includes identifying that the second node serves the preferred target cell, wherein the node addition request is sent to the second node in response to identifying that the second node serves the preferred target cell.

In some embodiments of the method 1700, the node addition request comprises an anchor change request for the second node to operate as an anchor cell for the UE in the DC mode; and the method 1700 further includes receiving, from the second node, a UE context relocation completion message indicating that the second node operates as the anchor cell for the UE in the DC mode.

In some embodiments of the method 1700, the DC request further comprises a measurement of a measured cell of the second node.

In some embodiments of the method 1700, the first CG comprises a plurality of cells of the first node.

In some embodiments of the method 1700, the second CG comprises a plurality of cells of the second node.

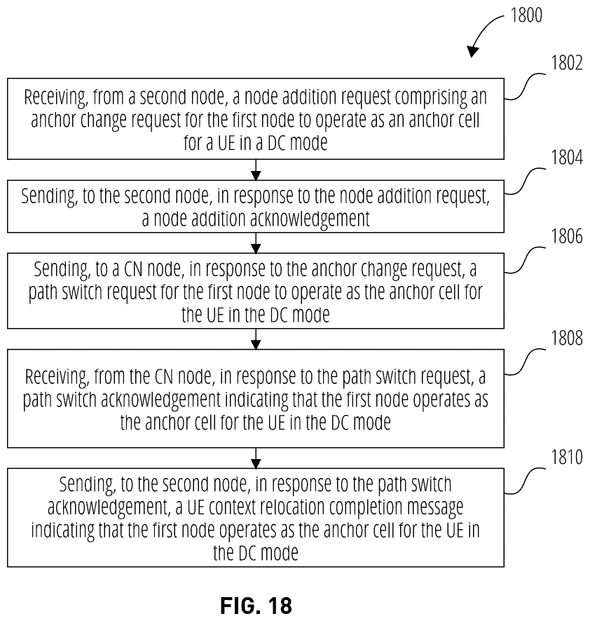

FIG. 18 illustrates a method 1800 of a first node, according to embodiments discussed herein. The method 1800 includes receiving 1802, from a second node, a node addition request comprising an anchor change request for the first node to operate as an anchor cell for a UE in a DC mode. The method 1800 further includes sending 1804, to the second node, in response to the node addition request, a node addition acknowledgement. The method 1800 further includes sending 1806 to a CN node, in response to the anchor change request, a path switch request for the first node to operate as the anchor cell for the UE in the DC mode. The method 1800 further includes receiving 1808, from the CN node, in response to the path switch request, a path switch acknowledgement indicating that the first node operates as the anchor cell for the UE in the DC mode. The method 1800 further includes sending 1810, to the second node, in response to the path switch acknowledgement, a UE context relocation completion message indicating that the first node operates as the anchor cell for the UE in the DC mode.

In some embodiments of the method 1800, the first node comprises a 6G node, and the second node comprises a 5G node.

In some embodiments of the method 1800, the first node comprises a first 6G node, and the second node comprises a second 6G node.

Note that while various embodiments discussed herein relate to cases for 6G MR-DC, it is contemplated that various solutions herein could be applied more generally in contexts of multiple 6G node (e.g., in “pure” 6G DC cases).

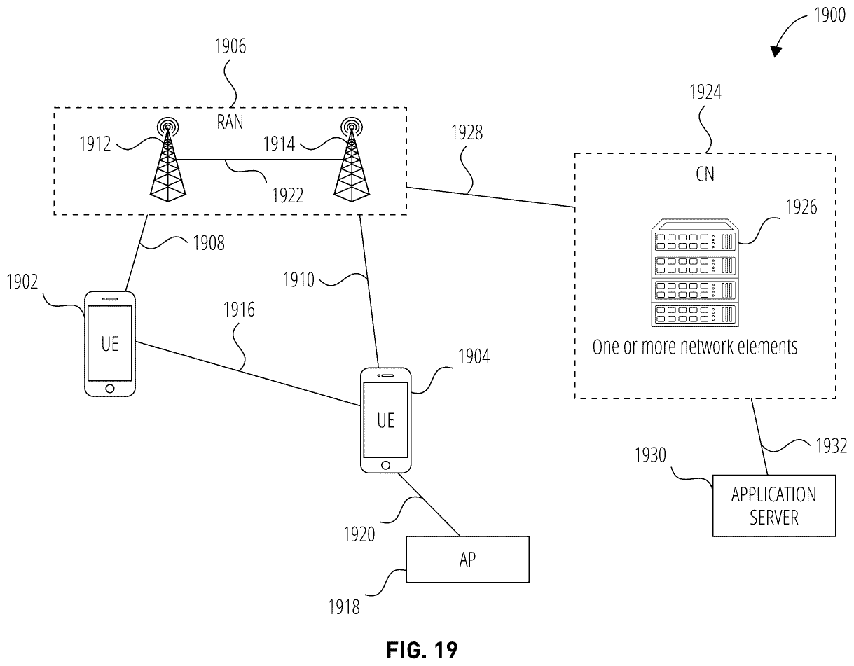

FIG. 19 illustrates an example architecture of a wireless communication system 1900, according to embodiments disclosed herein. The following description is provided for an example wireless communication system 1900 that operates in conjunction with the LTE system standards and/or 5G or NR system standards as provided by 3GPP technical specifications.

As shown by FIG. 19, the wireless communication system 1900 includes UE 1902 and UE 1904 (although any number of UEs may be used). In this example, the UE 1902 and the UE 1904 are illustrated as smartphones (e.g., handheld touchscreen mobile computing devices connectable to one or more cellular networks), but may also comprise any mobile or non-mobile computing device configured for wireless communication.

The UE 1902 and UE 1904 may be configured to communicatively couple with a RAN 1906. In embodiments, the RAN 1906 may be NG-RAN, E-UTRAN, etc. The UE 1902 and UE 1904 utilize connections (or channels) (shown as connection 1908 and connection 1910, respectively) with the RAN 1906, each of which comprises a physical communications interface. The RAN 1906 can include one or more base stations (such as base station 1912 and base station 1914) that enable the connection 1908 and connection 1910.

In this example, the connection 1908 and connection 1910 are air interfaces to enable such communicative coupling, and may be consistent with RAT(s) used by the RAN 1906, such as, for example, an LTE and/or NR.

In some embodiments, the UE 1902 and UE 1904 may also directly exchange communication data via a sidelink interface 1916. The UE 1904 is shown to be configured to access an access point (shown as AP 1918) via connection 1920. By way of example, the connection 1920 can comprise a local wireless connection, such as a connection consistent with any IEEE 802.11 protocol, wherein the AP 1918 may comprise a Wi-Fi® router. In this example, the AP 1918 may be connected to another network (for example, the Internet) without going through a CN 1924.

In embodiments, the UE 1902 and UE 1904 can be configured to communicate using orthogonal frequency division multiplexing (OFDM) communication signals with each other or with the base station 1912 and/or the base station 1914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1912 or base station 1914 may be implemented as one or more software entities running on server computers as part of a virtual network. In addition, or in other embodiments, the base station 1912 or base station 1914 may be configured to communicate with one another via interface 1922. In embodiments where the wireless communication system 1900 is an LTE system (e.g., when the CN 1924 is an EPC), the interface 1922 may be an X2 interface. The X2 interface may be defined between two or more base stations (e.g., two or more eNBs and the like) that connect to an EPC, and/or between two eNBs connecting to the EPC. In embodiments where the wireless communication system 1900 is an NR system (e.g., when CN 1924 is a 5GC), the interface 1922 may be an Xn interface. The Xn interface is defined between two or more base stations (e.g., two or more gNBs and the like) that connect to 5GC, between a base station 1912 (e.g., a gNB) connecting to 5GC and an eNB, and/or between two eNBs connecting to 5GC (e.g., CN 1924).

The RAN 1906 is shown to be communicatively coupled to the CN 1924. The CN 1924 may comprise one or more network elements 1926, which are configured to offer various data and telecommunications services to customers/subscribers (e.g., users of UE 1902 and UE 1904) who are connected to the CN 1924 via the RAN 1906. The components of the CN 1924 may be implemented in one physical device or separate physical devices including components to read and execute instructions from a machine-readable or computer-readable medium (e.g., a non-transitory machine-readable storage medium).

In embodiments, the CN 1924 may be an EPC, and the RAN 1906 may be connected with the CN 1924 via an S1 interface 1928. In embodiments, the S1 interface 1928 may be split into two parts, an S1 user plane (S1-U) interface, which carries traffic data between the base station 1912 or base station 1914 and a serving gateway (S-GW), and the S1-MME interface, which is a signaling interface between the base station 1912 or base station 1914 and mobility management entities (MMEs).

In embodiments, the CN 1924 may be a 5GC, and the RAN 1906 may be connected with the CN 1924 via an NG interface 1928. In embodiments, the NG interface 1928 may be split into two parts, an NG user plane (NG-U) interface, which carries traffic data between the base station 1912 or base station 1914 and a user plane function (UPF), and the S1 control plane (NG-C) interface, which is a signaling interface between the base station 1912 or base station 1914 and access and mobility management functions (AMFs).

Generally, an application server 1930 may be an element offering applications that use internet protocol (IP) bearer resources with the CN 1924 (e.g., packet switched data services). The application server 1930 can also be configured to support one or more communication services (e.g., VoIP sessions, group communication sessions, etc.) for the UE 1902 and UE 1904 via the CN 1924. The application server 1930 may communicate with the CN 1924 through an IP communications interface 1932.

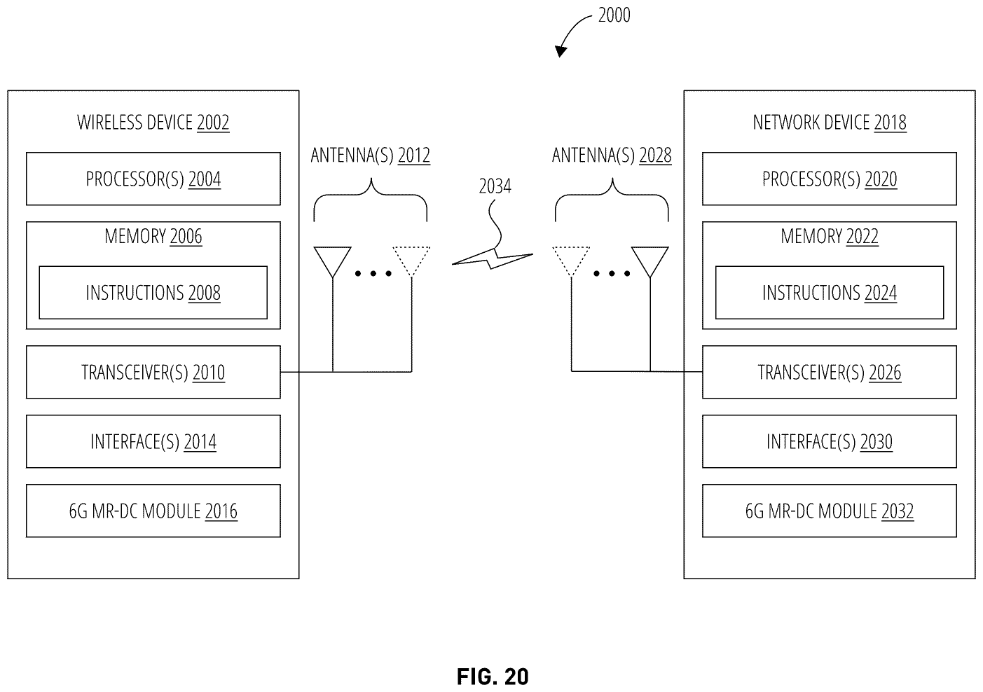

FIG. 20 illustrates a system 2000 for performing signaling 2034 between a wireless device 2002 and a network device 2018, according to embodiments disclosed herein. The system 2000 may be a portion of a wireless communications system as herein described. The wireless device 2002 may be, for example, a UE of a wireless communication system. The network device 2018 may be, for example, a base station (e.g., an eNB or a gNB) of a wireless communication system.

The wireless device 2002 may include one or more processor(s) 2004. The processor(s) 2004 may execute instructions such that various operations of the wireless device 2002 are performed, as described herein. The processor(s) 2004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 2002 may include a memory 2006. The memory 2006 may be a non-transitory computer-readable storage medium that stores instructions 2008 (which may include, for example, the instructions being executed by the processor(s) 2004). The instructions 2008 may also be referred to as program code or a computer program. The memory 2006 may also store data used by, and results computed by, the processor(s) 2004.

The wireless device 2002 may include one or more transceiver(s) 2010 that may include radio frequency (RF) transmitter circuitry and/or receiver circuitry that use the antenna(s) 2012 of the wireless device 2002 to facilitate signaling (e.g., the signaling 2034) to and/or from the wireless device 2002 with other devices (e.g., the network device 2018) according to corresponding RATs.

The wireless device 2002 may include one or more antenna(s) 2012 (e.g., one, two, four, or more). For embodiments with multiple antenna(s) 2012, the wireless device 2002 may leverage the spatial diversity of such multiple antenna(s) 2012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 2002 may be accomplished according to precoding (or digital beamforming) that is applied at the wireless device 2002 that multiplexes the data streams across the antenna(s) 2012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 2002 may implement analog beamforming techniques, whereby phases of the signals sent by the antenna(s) 2012 are relatively adjusted such that the (joint) transmission of the antenna(s) 2012 can be directed (this is sometimes referred to as beam steering).

The wireless device 2002 may include one or more interface(s) 2014. The interface(s) 2014 may be used to provide input to or output from the wireless device 2002. For example, a wireless device 2002 that is a UE may include interface(s) 2014 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 2010/antenna(s) 2012 already described) that allow for communication between the UE and other devices and may operate according to known protocols (e.g., Wi-Fi®, Bluetooth®, and the like).

The wireless device 2002 may include a 6G MR-DC module 2016. The 6G MR-DC module 2016 may be implemented via hardware, software, or combinations thereof. For example, the 6G MR-DC module 2016 may be implemented as a processor, circuit, and/or instructions 2008 stored in the memory 2006 and executed by the processor(s) 2004. In some examples, the 6G MR-DC module 2016 may be integrated within the processor(s) 2004 and/or the transceiver(s) 2010. For example, the 6G MR-DC module 2016 may be implemented by a combination of software components (e.g., executed by a DSP or a general processor) and hardware components (e.g., logic gates and circuitry) within the processor(s) 2004 or the transceiver(s) 2010.

The 6G MR-DC module 2016 may be used for various aspects of the present disclosure, for example, aspects of FIG. 16. For example, the 6G MR-DC module 2016 may configure the wireless device 2002 to establish a connection with a first node through a first CG of the first node; send, to the first node, a DC request comprising an indication of a preferred target cell; receive, from the first node, in response to the DC request, a configuration message comprising an identification of a second CG of a second node to use with the first CG of the first node in a DC mode; and initiate, in response to the configuration message, the DC mode with the first CG of the first node and the second CG of the second node.

The network device 2018 may include one or more processor(s) 2020. The processor(s) 2020 may execute instructions such that various operations of the network device 2018 are performed, as described herein. The processor(s) 2020 may include one or more baseband processors implemented using, for example, a CPU, a DSP, an ASIC, a controller, an FPGA device, another hardware device, a firmware device, or any combination thereof configured to perform the operations described herein.

The network device 2018 may include a memory 2022. The memory 2022 may be a non-transitory computer-readable storage medium that stores instructions 2024 (which may include, for example, the instructions being executed by the processor(s) 2020). The instructions 2024 may also be referred to as program code or a computer program. The memory 2022 may also store data used by, and results computed by, the processor(s) 2020.

The network device 2018 may include one or more transceiver(s) 2026 that may include RF transmitter circuitry and/or receiver circuitry that use the antenna(s) 2028 of the network device 2018 to facilitate signaling (e.g., the signaling 2034) to and/or from the network device 2018 with other devices (e.g., the wireless device 2002) according to corresponding RATs.

The network device 2018 may include one or more antenna(s) 2028 (e.g., one, two, four, or more). In embodiments having multiple antenna(s) 2028, the network device 2018 may perform MIMO, digital beamforming, analog beamforming, beam steering, etc., as has been described.

The network device 2018 may include one or more interface(s) 2030. The interface(s) 2030 may be used to provide input to or output from the network device 2018. For example, a network device 2018 that is a base station may include interface(s) 2030 made up of transmitters, receivers, and other circuitry (e.g., other than the transceiver(s) 2026/antenna(s) 2028 already described) that enables the base station to communicate with other equipment in a core network, and/or that enables the base station to communicate with external networks, computers, databases, and the like for purposes of operations, administration, and maintenance of the base station or other equipment operably connected thereto.

The network device 2018 may include a 6G MR-DC module 2032. The 6G MR-DC module 2032 may be implemented via hardware, software, or combinations thereof. For example, the 6G MR-DC module 2032 may be implemented as a processor, circuit, and/or instructions 2024 stored in the memory 2022 and executed by the processor(s) 2020. In some examples, the 6G MR-DC module 2032 may be integrated within the processor(s) 2020 and/or the transceiver(s) 2026. For example, the 6G MR-DC module 2032 may be implemented by a combination of software components (e.g., executed by a DSP or a general processor) and hardware components (e.g., logic gates and circuitry) within the processor(s) 2020 or the transceiver(s) 2026.

The 6G MR-DC module 2032 may be used for various aspects of the present disclosure, for example, aspects of FIG. 17 and/or FIG. 18. For example, the 6G MR-DC module 2032 may configure the network device 2018 to establish a connection with a UE on a first CG of the first node; receive, from the UE, a DC request comprising an indication of a preferred target cell; send, to a second node, in response to the DC request, a node addition request; receive, from the second node, in response to the node addition request, a node addition acknowledgement; and send, to the UE, in response to the node addition acknowledgement, a configuration message comprising an identification of a second CG of the second node to use with the first CG of the first node in a DC mode.

As another example, the 6G MR-DC module 2032 may configure the network device 2018 to receive, from a second node, a node addition request comprising an anchor change request for the first node to operate as an anchor cell for a UE in a DC mode; send, to the second node, in response to the node addition request, a node addition acknowledgement; send, to a CN node, in response to the anchor change request, a path switch request for the first node to operate as the anchor cell for the UE in the DC mode; receive, from the CN node, in response to the path switch request, a path switch acknowledgement indicating that the first node operates as the anchor cell for the UE in the DC mode; and send, to the second node, in response to the path switch acknowledgement, a UE context relocation completion message indicating that the first node operates as the anchor cell for the UE in the DC mode.

Embodiments contemplated herein include an apparatus comprising means to perform one or more elements of the method 1600. This apparatus may be, for example, an apparatus of a UE (such as a wireless device 2002 that is a UE, as described herein).

Embodiments contemplated herein include one or more non-transitory computer-readable media comprising instructions to cause an electronic device, upon execution of the instructions by one or more processors of the electronic device, to perform one or more elements of the method 1600. This non-transitory computer-readable media may be, for example, a memory of a UE (such as a memory 2006 of a wireless device 2002 that is a UE, as described herein).

Embodiments contemplated herein include an apparatus comprising logic, modules, or circuitry to perform one or more elements of the method 1600. This apparatus may be, for example, an apparatus of a UE (such as a wireless device 2002 that is a UE, as described herein).

Embodiments contemplated herein include an apparatus comprising: one or more processors and one or more computer-readable media comprising instructions that, when executed by the one or more processors, cause the one or more processors to perform one or more elements of the method 1600. This apparatus may be, for example, an apparatus of a UE (such as a wireless device 2002 that is a UE, as described herein).

Embodiments contemplated herein include a signal as described in or related to one or more elements of the method 1600.

Embodiments contemplated herein include a computer program or computer program product comprising instructions, wherein execution of the program by a processor is to cause the processor to carry out one or more elements of the method 1600. The processor may be a processor of a UE (such as a processor(s) 2004 of a wireless device 2002 that is a UE, as described herein). These instructions may be, for example, located in the processor and/or on a memory of the UE (such as a memory 2006 of a wireless device 2002 that is a UE, as described herein).

Embodiments contemplated herein include an apparatus comprising means to perform one or more elements of any of the method 1700 and the method 1800. This apparatus may be, for example, an apparatus of a base station (such as a network device 2018 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 1700 and the method 1800. This non-transitory computer-readable media may be, for example, a memory of a base station (such as a memory 2022 of a network device 2018 that is a base station, as described herein).

Embodiments contemplated herein include an apparatus comprising logic, modules, or circuitry to perform one or more elements of any of the method 1700 and the method 1800. This apparatus may be, for example, an apparatus of a base station (such as a network device 2018 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 1700 and the method 1800. This apparatus may be, for example, an apparatus of a base station (such as a network device 2018 that is a base station, as described herein).

Embodiments contemplated herein include a signal as described in or related to one or more elements of any of the method 1700 and the method 1800.

Embodiments contemplated herein include a computer program or computer program product comprising instructions, wherein execution of the program by a processing element is to cause the processing element to carry out one or more elements of any of the method 1700 and the method 1800. The processor may be a processor of a base station (such as a processor(s) 2020 of a network device 2018 that is a base station, as described herein). These instructions may be, for example, located in the processor and/or on a memory of the base station (such as a memory 2022 of a network device 2018 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
establishing a connection with a first node through a first cell group (CG) of the first node;
sending, to the first node, a dual connectivity (DC) request comprising an indication of a preferred target cell;
receiving, from the first node, in response to the DC request, a configuration message comprising an identification of a second CG of a second node to use with the first CG of the first node in a DC mode; and
initiating, in response to the configuration message, the DC mode with the first CG of the first node and the second CG of the second node.

2. The method of claim 1, wherein:
the first node comprises a 5G node and the first CG comprises a 5G CG; and
the second node comprises a 6G node and the second CG comprises a 6G CG.

3. The method of claim 1, wherein the second CG for the second node comprises the preferred target cell.

4. The method of claim 1, wherein the DC request further comprises a measurement of a measured cell of the second node.

5. The method of claim 1, further comprising:
receiving, from one of the first node and the second node, a master key and an indication of an indicated CG of the first CG and the second CG for which to use the master key; and
generating a derived key for use with a non-indicated CG of the first CG and the second CG based on the master key; and
while the UE is in the DC mode:
performing a first communication on the indicated CG using the master key; and
performing a second communication on the non-indicated CG using the derived key.

6. The method of claim 1, further comprising:
receiving, from one of the first node and the second node, a master key, a first key counter (K-counter) for the first CG, and a second K-counter for the second CG;
generating a first derived key for use with the first CG based on the master key and the first K-counter; and
generating a second derived key for use with the second CG based on the master key and the second K-counter; and
while the UE is in the DC mode:
performing a first communication on the first CG using the first derived key; and
performing a second communication on the second CG using the second derived key.

7. The method of claim 1, further comprising, while the UE is in the DC mode:
communicating over the first CG at a first time at which the first CG is activated and the second CG is deactivated; and
communicating over the second CG at a second time at which the first CG is deactivated and the second CG is activated.

8. The method of claim 1, further comprising, while the UE is in the DC mode:
determining, while the first CG is active and the second CG is inactive, that a measurement quality of the second CG meets a threshold; and
initiating, in response to determining that the measurement quality of the second CG meets the threshold, an activation of the second CG and a deactivation of the first CG.

9. The method of claim 1, further comprising, while the UE is in the DC mode:
determining, while the first CG is active and the second CG is inactive, that a measurement quality of the first CG does not meet a threshold; and
initiating, in response to determining that the measurement quality of the first CG does not meet the threshold, an activation of the second CG and a deactivation of the first CG.

10. The method of claim 1, further comprising, while the UE is in the DC mode:
determining, while the first CG is active and the second CG is inactive, that a first measurement quality of the first CG does not meet a threshold and that a second measurement quality of the second CG meets the threshold; and
initiating, in response to determining that the first measurement quality of the first CG does not meet the threshold and that the second measurement quality of the second CG meets the threshold, an activation of the second CG and a deactivation of the first CG.

11. The method of claim 1, further comprising:
receiving configuration information indicating that traffic of a configured traffic type is to be communicated through the first CG; and
while the UE is in the DC mode:
identifying, while the first CG is deactivated, that the UE is to transmit the traffic of the configured traffic type; and
initiating, in response to determining that the UE is to transmit the traffic of the configured traffic type, an activation of the first CG.

12. The method of claim 1, further comprising:
receiving configuration information indicating that traffic of a configured traffic type is to be communicated through the first CG; and
while the UE is in the DC mode:
identifying, while the first CG is activated, that there has been no traffic of the configured traffic type during a time period; and
initiating, in response to determining that there has been no traffic of the configured traffic type during the time period, a deactivation of the first CG.

13. The method of claim 1, further comprising, while the UE is in the DC mode:
identifying, while the first CG is activated, that a power level of the UE does not meet a threshold; and
initiating, in response to determining that the power level of the UE does not meet the threshold, a deactivation of the first CG.

14. A method of a first node, comprising:
establishing a connection with a user equipment (UE) on a first cell group (CG) of a first node;
receiving, from the UE, a dual connectivity (DC) request comprising an indication of a preferred target cell;
sending, to a second node, in response to the DC request, a node addition request;
receiving, from the second node, in response to the node addition request, a node addition acknowledgement; and
sending, to the UE, in response to the node addition acknowledgement, a configuration message comprising an identification of a second CG of the second node to use with the first CG of the first node in a DC mode.

15. The method of claim 14, further comprising identifying that the second node serves the preferred target cell, wherein the node addition request is sent to the second node in response to identifying that the second node serves the preferred target cell.

16. The method of claim 14, wherein the node addition request comprises an anchor change request for the second node to operate as an anchor cell for the UE in the DC mode; and further comprising receiving, from the second node, a UE context relocation completion message indicating that the second node operates as the anchor cell for the UE in the DC mode.

17. The method of claim 14, wherein the DC request further comprises a measurement of a measured cell of the second node.

18. A method of a first node, comprising:
receiving, from a second node, a node addition request comprising an anchor change request for the first node to operate as an anchor cell for a user equipment (UE) in a dual connectivity (DC) mode;
sending, to the second node, in response to the node addition request, a node addition acknowledgement;
sending, to a core network (CN) node, in response to the anchor change request, a path switch request for the first node to operate as the anchor cell for the UE in the DC mode;
receiving, from the CN node, in response to the path switch request, a path switch acknowledgement indicating that the first node operates as the anchor cell for the UE in the DC mode; and
sending, to the second node, in response to the path switch acknowledgement, a UE context relocation completion message indicating that the first node operates as the anchor cell for the UE in the DC mode.

19. The method of claim 18, wherein:
the first node comprises a 6G node, and
the second node comprises a 5G node.

20. The method of claim 18, wherein:
the first node comprises a first 6G node, and
the second node comprises a second 6G node.
